(19) United States
(12) Patent Application Publication
(10) Pub. No.: US 2018/0263239 A1
(43) Pub. Date: Sep. 20, 2018

(54) SEALABLE TRAY SYSTEM AND METHODS OF USING SAME

(71) Applicant: OSIRIS THERAPEUTICS, INC., Columbia, MD (US)

(72) Inventors: STEVEN MICHAEL SINCLAIR, Austin, TX (US); YI DUAN-ARNOLD, Ellicott City, MD (US); ALEXANDRA GYURDIEVA, Elkridge, MD (US); AMY ELIZABETH JOHNSON, Baltimore, MD (US); THOMAS EDWARD UVEGES, Elkridge, MD (US); SANDRA D. GERAGHTY, Elkridge, MD (US); JIN-QIANG KUANG, Glenelg, MD (US); ALLA DANILKOVITCH, Columbia, MD (US)

(21) Appl. No.: 15/820,597

(22) Filed: Nov. 22, 2017

Related U.S. Application Data
(60) Provisional application No. 62/425,224, filed on Nov. 22, 2016.

(51) Int. Cl. A01N 1/02; B65D 25/10; B65D 51/18

(52) U.S. Cl. CPC A01N 1/0273; B65D 25/10; B65D 2251/0081; B65D 2251/0018; B65D 51/18

(57) ABSTRACT

A sealable tray system for sealing a product in a transport-ready position. The sealable tray system has an insert, a first lid, an outer basin, and a second lid. The insert has a well portion with a base surface that extends upwardly to support the product. The insert also has a flange portion that extends outwardly from the well portion and is sealingly engaged by the first lid. The outer basin receives the insert in the transport-ready position, and the second lid engages a top surface of the outer basin. Methods of sealing a product in a transport-ready position are also disclosed.

### CROSS-REFERENCE TO RELATED APPLICATIONS

This application claims priority to and the benefit of the filing date of U.S. Provisional Application No. 62/425,224, filed Nov. 22, 2016, which application is incorporated herein by reference in its entirety.

### FIELD

This application relates to product packaging systems, and more particularly, to sealable tray systems and methods, including sealable tray systems and methods for sealing a product in a transport-ready position.

### BACKGROUND

Conventionally, product packaging is specifically designed for products of a particular size, and each product size requires product packaging of a corresponding size. Consequently, modifications of products often necessitate corresponding modifications to the product packaging, and product packaging often must be designed for each new product. Moreover, the incompatibility of product packaging with products of various sizes leads to wastefulness, inefficiency, and a loss of flexibility in the manufacturing and packaging process.

Therefore, there is a need within the art for product packaging systems that can be used with a variety of products. There is a further need in the art for product packaging systems that can be used with a variety of medical products, while maintaining the sterility of the medical products and permitting the use of the product packaging within a sterile environment.

### SUMMARY

Described herein, in one aspect, is a sealable tray system for sealing a product in a transport-ready position. The sealable tray system can have an insert, a first lid, an outer basin, and a second lid. The insert can have a central axis, a flange portion, and a well portion. The flange portion can have a top surface and a bottom surface, and the well portion can have a side wall and a base surface. The side wall can be connected to and extend between the flange portion of the insert and the base surface of the well portion, and the side wall can have an inner surface and an outer surface. The base surface of the well portion can define at least one projection that extends upwardly relative to the central axis of the insert and is configured to support the tissue product. The flange portion can extend radially outwardly from the outer surface of the side wall of the well portion relative to the central axis of the insert. The first lid can be configured to sealingly engage the top surface of the flange portion of the insert. The outer basin can be configured to receive the insert in the transport-ready position. The outer basin can have a central axis, a flange portion, a ledge portion, a base surface, and a side wall. The flange portion can define a top surface of the outer basin, and the side wall of the outer basin can have an inner surface and an outer surface and be connected to and extend upwardly from the base surface of the outer basin relative to the central axis of the outer basin. The ledge portion of the outer basin can be connected to and extend between the flange portion and the side wall. The flange portion can extend radially outwardly from the ledge portion relative to the central axis of the outer basin. The ledge portion of the outer basin can define a ledge surface that is recessed from the top surface of the outer basin relative to the central axis and that extends radially inwardly from the flange portion relative to the central axis. The second lid can be configured to sealingly engage the top surface of the outer basin. The ledge surface of the outer basin can be configured for engagement with the bottom surface of the flange portion of the insert to thereby support the insert in the transport-ready position.

In another aspect, described herein are methods of sealing a product in a transport-ready position. The method can include positioning the product within an insert of a sealable tray system as described herein. The method can also include positioning a first lid over the well portion of the insert to seal the product within the insert, with the first lid sealingly engaging the top surface of the flange portion of the insert. The method can further include positioning the insert within the outer basin of the sealable tray system in the transport-ready position. The method can still further include positioning the second lid of the sealable tray system over the outer basin to seal the insert within the outer basin, with the second lid sealingly engaging the top surface of the outer basin.

### DESCRIPTION OF THE DRAWINGS

FIGS. 1A-1B are top perspective views of an exemplary outer basin as disclosed herein. FIGS. 1C-1D are bottom perspective views of the outer basin of FIG. 1A. FIGS. 1E-1F are top and bottom plan views of the outer basin of FIG. 1A. FIGS. 1G-1I are various side views of the outer basin of FIG. 1A. FIGS. 1J-1L are various cross-sectional views of the outer basin of FIG. 1A, taken along respective section lines (lines 1J-1J, 1K-1K, and 1L-1L) of FIG. 1E.

FIG. 2 is a top lid of an exemplary lid for covering and engaging a top surface of an outer basin as disclosed herein.

FIGS. 3A-3B are top perspective views of an exemplary insert as disclosed herein.

FIGS. 3C-3D are bottom perspective views of the insert of FIG. 3A. FIGS. 3E-3F are top and bottom plan views of the insert of FIG. 3A. FIGS. 3G-3I are various side views of the insert of FIG. 3A. FIGS. 3J-3O are various cross-sectional views of the insert of FIG. 3A, taken along respective section lines (lines 3J-3J, 3K-3K, 3L-3L, 3M-3M, 3N-3N, and 3O-3O) of FIG. 3E.

FIGS. 4A-4B are top perspective views of another exemplary insert as disclosed herein. FIGS. 4C-4D are bottom perspective views of the insert of FIG. 4A. FIGS. 4E-4F are top and bottom plan views of the insert of FIG. 4A. FIGS. 4G-4I are various side views of the insert of FIG. 4A. FIGS. 4J-4O are various cross-sectional views of the insert of FIG. 4A, taken along respective section lines (lines 4J-4J, 4K-4K, 4L-4L, 4M-4M, 4N-4N, and 4O-4O) of FIG. 4E.

FIG. 5 is a top view of an exemplary lid for covering and engaging a top surface of the flange portion of an insert as disclosed herein.

FIG. 6 is a top perspective view of an exemplary insert in engagement with an outer basin as disclosed herein, with the lids for the insert and the basin omitted.

FIG. 7 is a top perspective view of another exemplary insert in engagement with an outer basin as disclosed herein, with the lids for the insert and the basin omitted.

FIG. 8 is a schematic diagram showing the ability of an outer basin as disclosed herein to receive inserts of various sizes as disclosed herein.

FIGS. 9A-18B, the exemplary, non-limiting dimensions provided in the drawings are given in centimeters.

FIGS. 9A-9C are schematic diagrams depicting top (FIG. 9A) and side (FIG. 9B) views of an exemplary insert as disclosed herein and the positioning of an insert in engagement with an outer basin (FIG. 9C) as disclosed herein.

FIGS. 10A-10C are schematic diagrams depicting top (FIG. 10A) and side (FIG. 10B) views of an exemplary insert as disclosed herein and the positioning of an insert in engagement with an outer basin (FIG. 10C) as disclosed herein.

FIGS. 11A-11C are schematic diagrams showing the positioning of various products within the insert of FIGS. 10A-10C as disclosed herein.

FIGS. 12A-12C are schematic diagrams depicting top (FIG. 12A) and side (FIG. 12B) views of an exemplary insert as disclosed herein and the positioning of an insert in engagement with an outer basin (FIG. 12C) as disclosed herein.

FIGS. 13A-13C are schematic diagrams depicting top (FIG. 13A) and side (FIG. 13B) views of an exemplary insert as disclosed herein and the positioning of an insert in engagement with an outer basin (FIG. 13C) as disclosed herein.

FIGS. 14A-14C are schematic diagrams showing the positioning of various products within the insert of FIGS. 13A-13C as disclosed herein.

FIGS. 15A-15C are schematic diagrams depicting top (FIG. 15A) and side (FIGS. 15B and 15C) views of an exemplary outer basin as disclosed herein.

FIGS. 16A-16C are schematic diagrams depicting top (FIG. 16A) and side (FIG. 16B) views of an exemplary insert as disclosed herein and the positioning of an insert in engagement with an outer basin (FIG. 16C) as disclosed herein.

FIGS. 17A-17C are schematic diagrams depicting top (FIG. 17A) and side (FIG. 17B) views of an exemplary insert as disclosed herein and the positioning of an insert in engagement with an outer basin (FIG. 17C) as disclosed herein.

FIGS. 18A-18B are schematic diagrams depicting top (FIG. 18A) and side (FIG. 18B) views of an exemplary outer basin as disclosed herein.

FIG. 19 is a schematic diagram depicting the engagement between an exemplary insert and an exemplary outer basin as disclosed herein.

FIGS. 20A-20B are schematic diagrams depicting an outer basin with a ledge portion having radial projections as disclosed herein.

FIGS. 21A-21C depict various thawing methods used with an exemplary tray system in an experimental example as disclosed herein. FIGS. 21D and 21E are graphs representing a comparison of cell viability in products stored within exemplary tray systems and cell viability in products stored within a cryobag.

FIGS. 22A-22E depict various stages of an experiment that evaluated post-cryopreservation properties of products packaged in a tray system and products packaged in a vial. FIG. 22A depicts the appearance of a product covered by a cryopreservation solution within a tray system. FIGS. 22B and 22C depict the covering of the inner and outer trays of the tray system with corresponding covers and the placement of the tray system within a container (box). FIG. 22D depicts the placement of the tray system container within a styrofoam box in a freezer. FIG. 22E depicts placement of the tray system container within a controlled-rate freezer.

FIG. 22F depicts the appearance of an exemplary tray system after thawing of the product within the tray system.

FIG. 23 is an image depicting placement of a product within a tray system in accordance with another experimental example.

Although the figures depict particular shapes and appearances of the components of the tray system disclosed herein, it is understood that, except as set forth herein, the specific shapes and appearances of the components of the tray system depicted in the accompanying figures are not required to achieve the disclosed functionality of the system components. Thus, it is understood that other shapes and appearances of the disclosed system components can be used to achieve the disclosed functionality of the system components.

### DETAILED DESCRIPTION

The present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout. It is to be understood that this invention is not limited to the particular methodology and protocols described, as such may vary. It is also to be understood that the terminology used herein is for the purpose of describing particular embodiments only, and is not intended to limit the scope of the present invention.

Many modifications and other embodiments of the invention set forth herein will come to mind to one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

As used herein the singular forms “a”, “an”, and “the” include plural referents unless the context clearly dictates otherwise. Thus, for example, reference to “a projection” can include a plurality of such projections, and so forth. All technical and scientific terms used herein have the same meaning as commonly understood to one of ordinary skill in the art to which this invention belongs unless clearly indicated otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. Optionally, in some aspects, when values are approximated by use of the antecedent “about,” it is contemplated that values within up to 10% or up to 5% (above or below) of the particularly stated value can be included within the scope of those aspects. Similarly, in some optional aspects, when values are approximated by use of the term “substantially,” it is contemplated that values within up to 15%, up to 10%, or up to 5% (above or below) of the particular value can be included within the scope of those aspects.

As used herein, the terms “optional” or “optionally” mean that the subsequently described event or circumstance may or may not occur, and that the description includes instances where said event or circumstance occurs and instances where it does not.

The word “or” as used herein means any one member of a particular list and also includes any combination of members of that list.

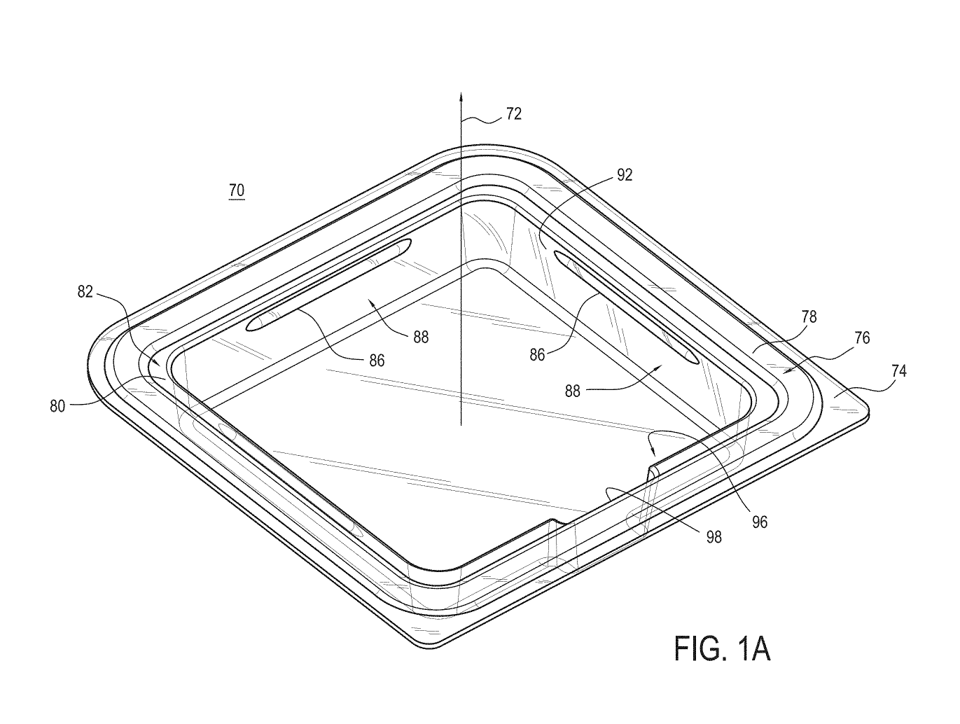

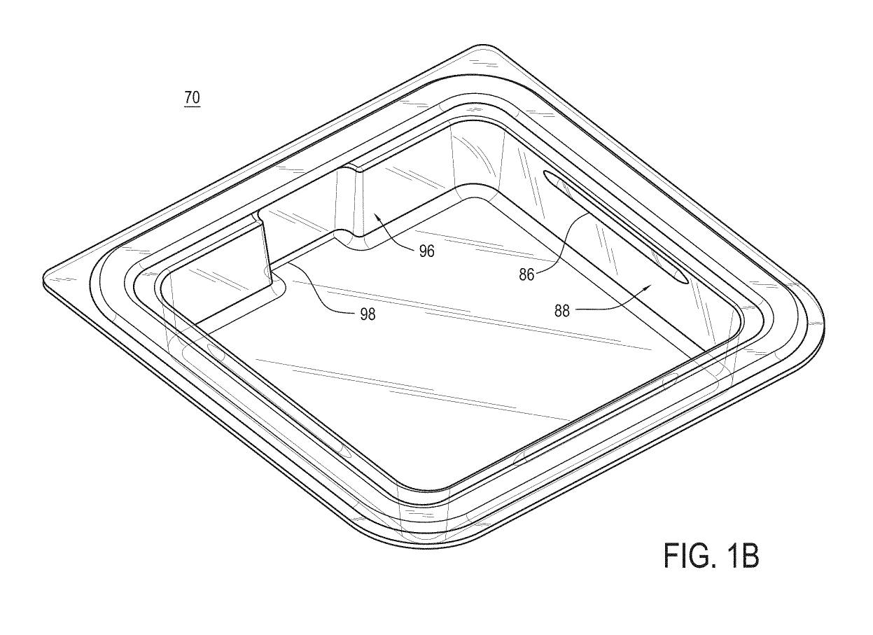

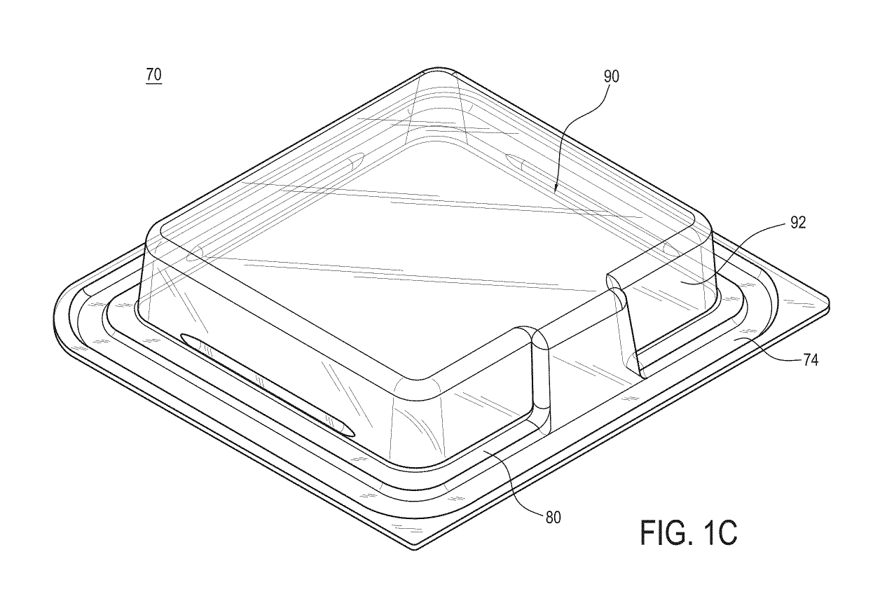

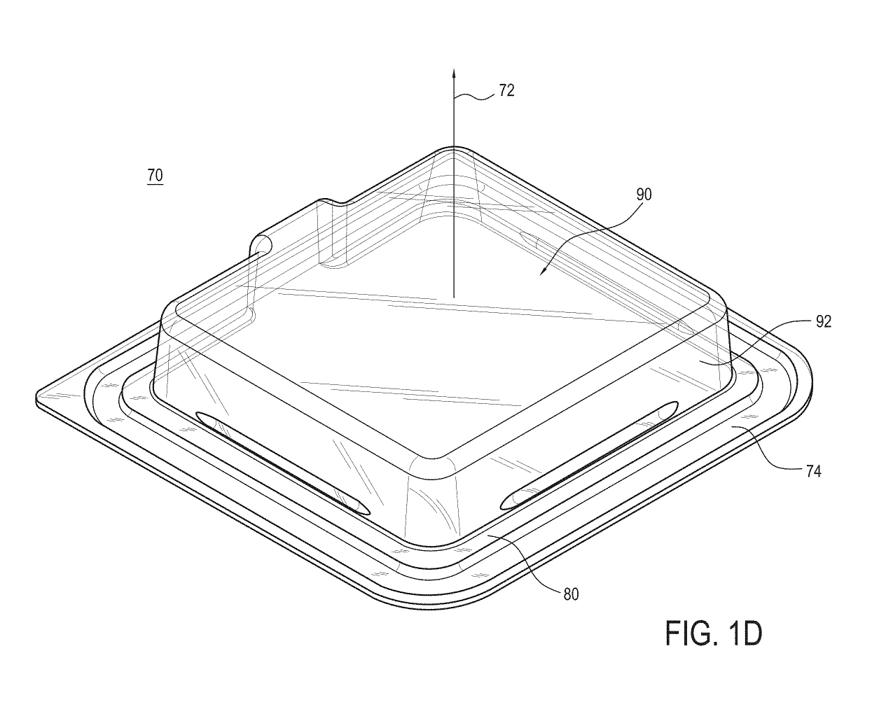

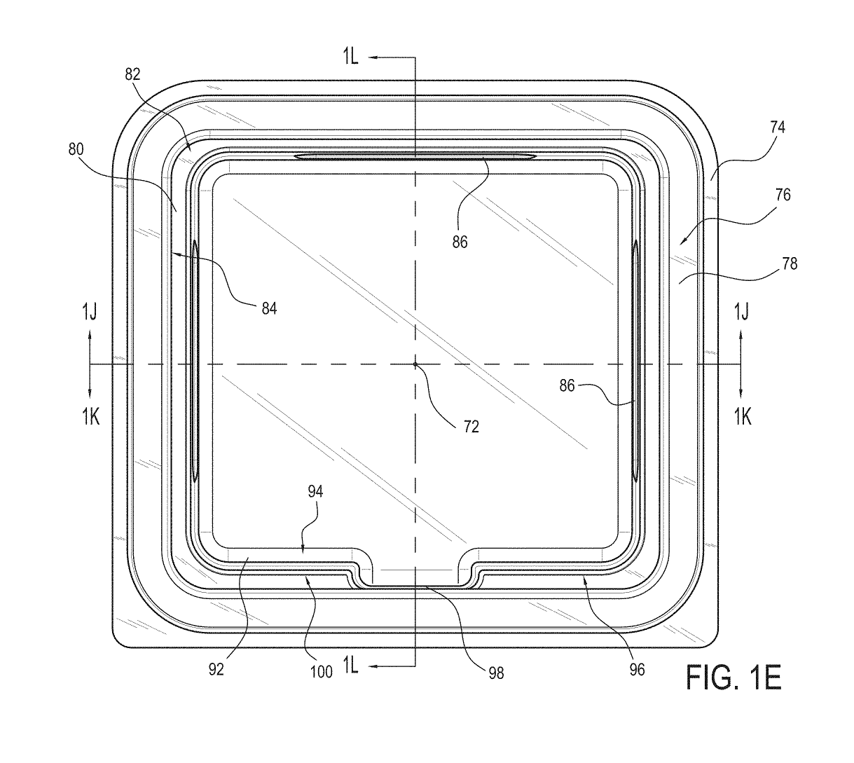

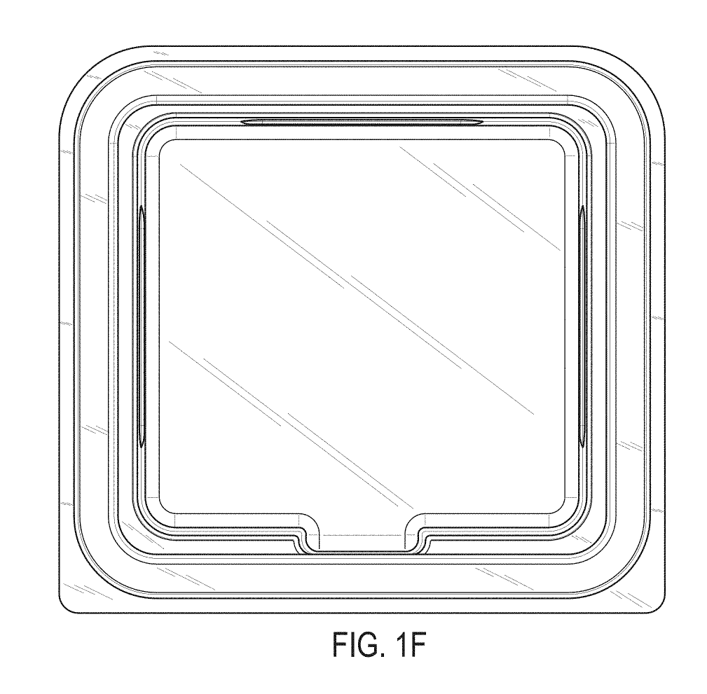

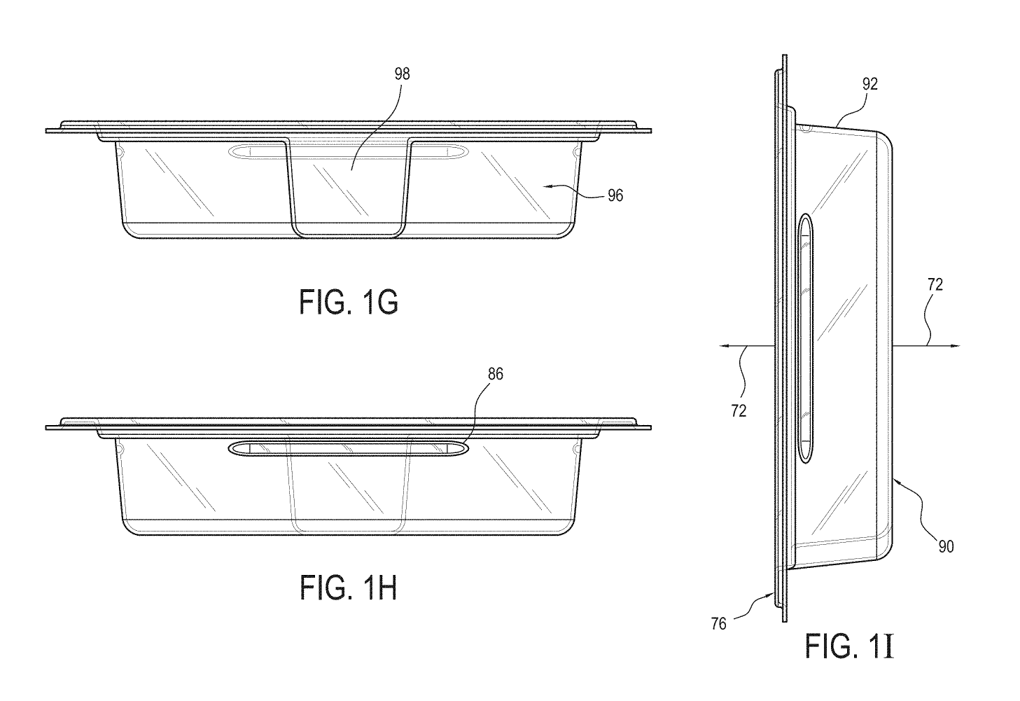

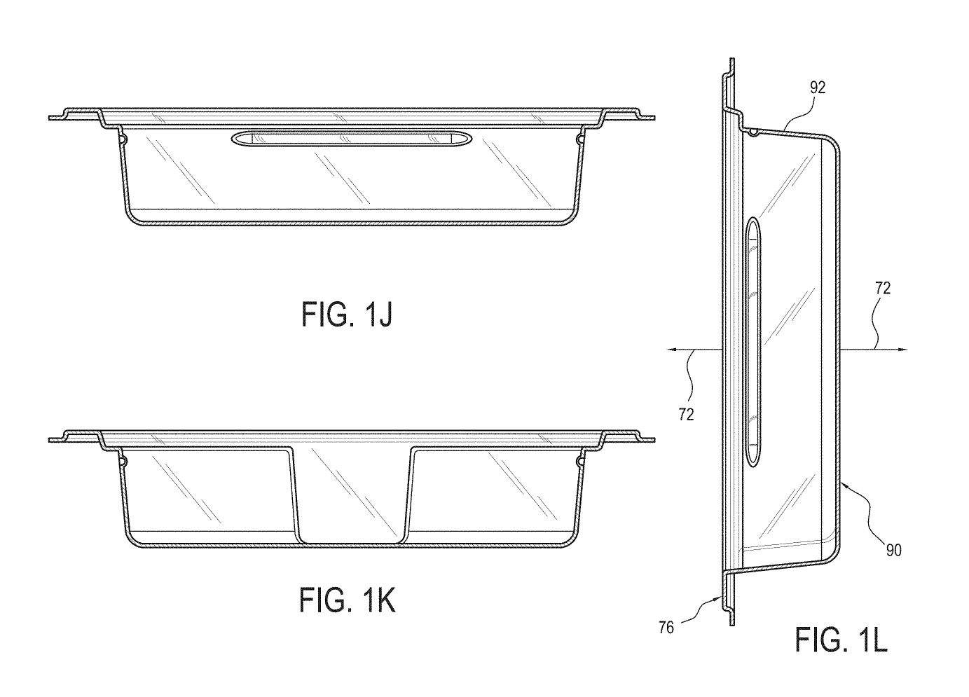

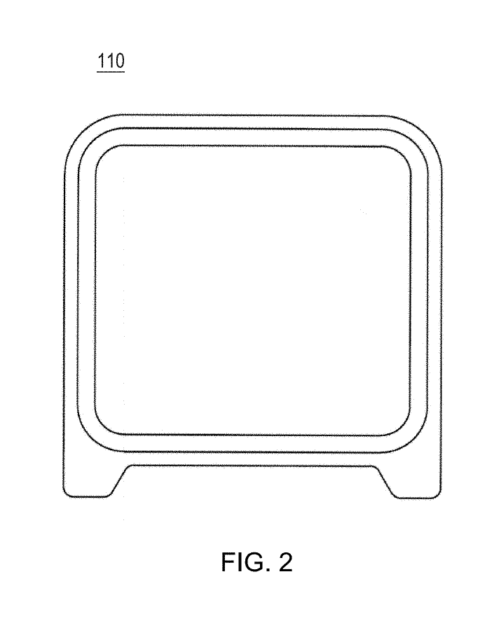

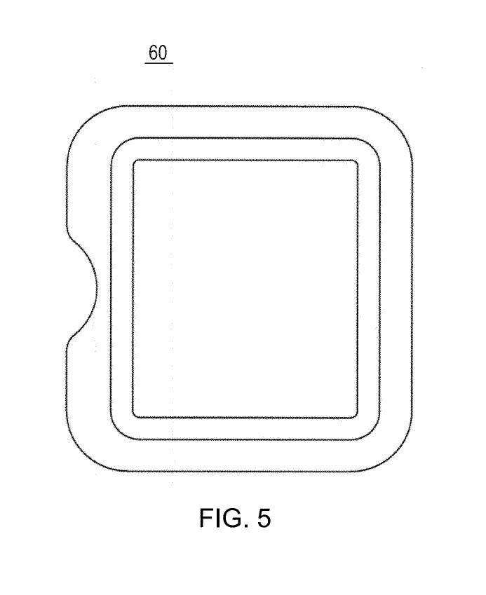

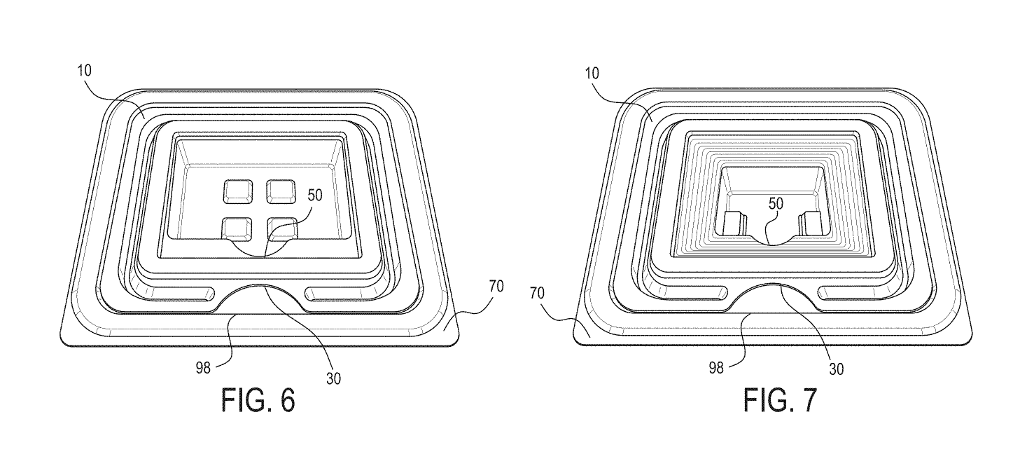

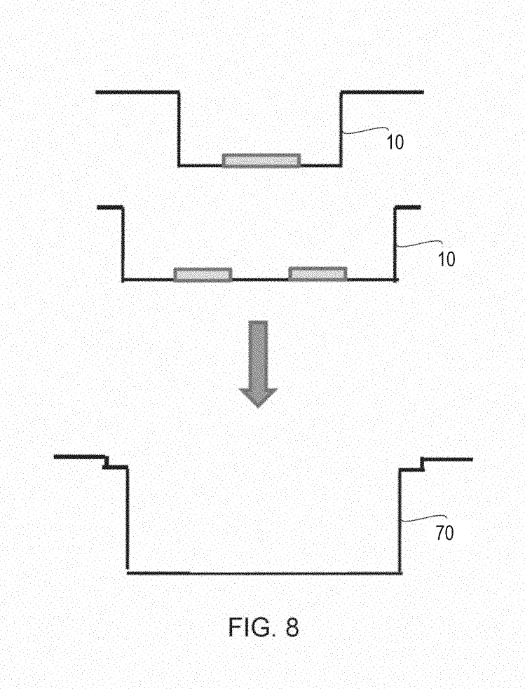

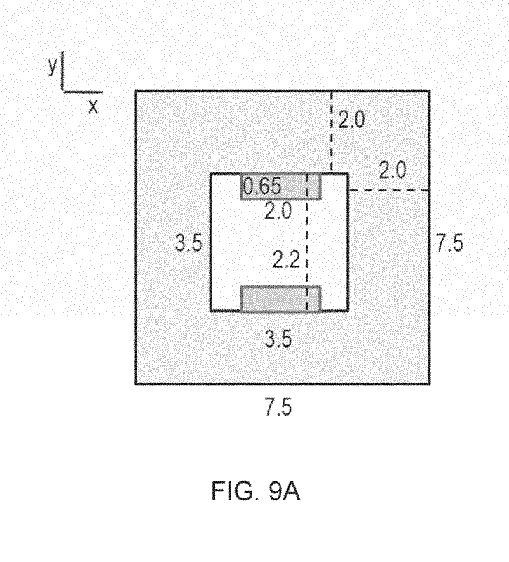

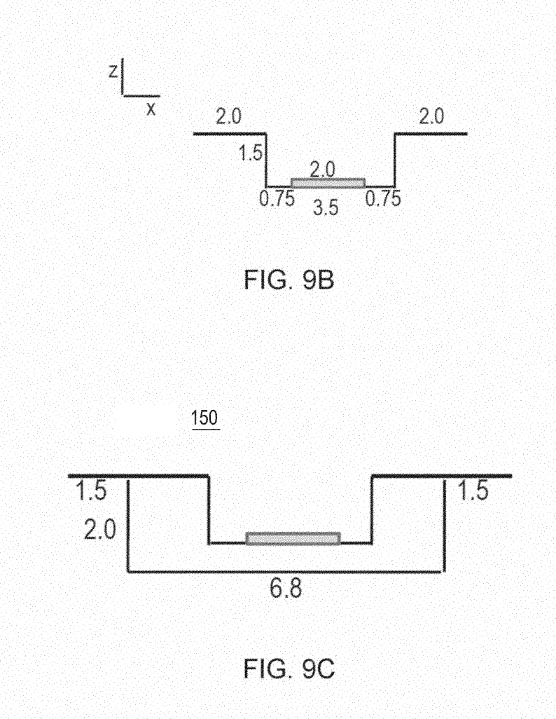

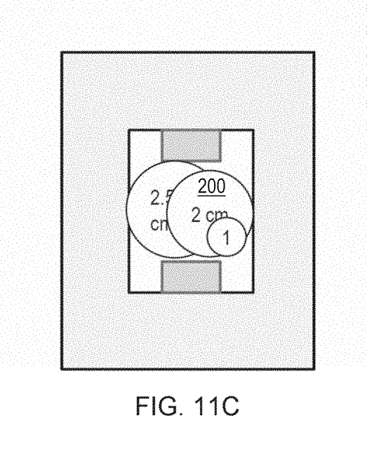

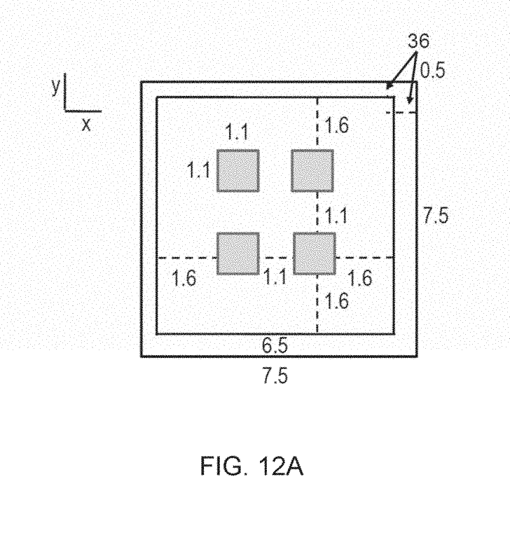

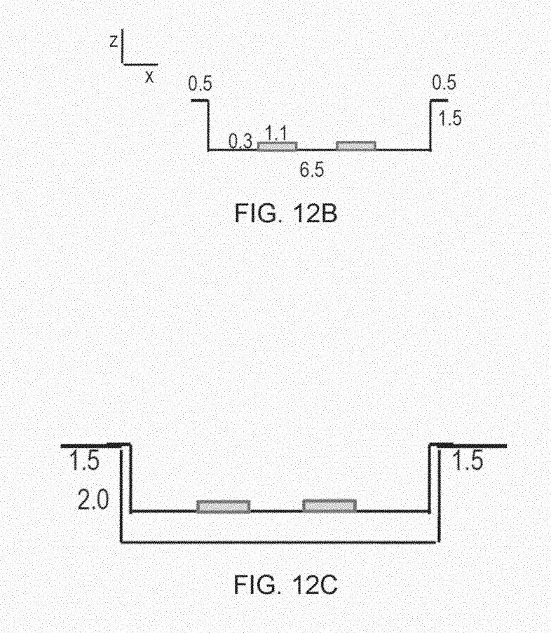

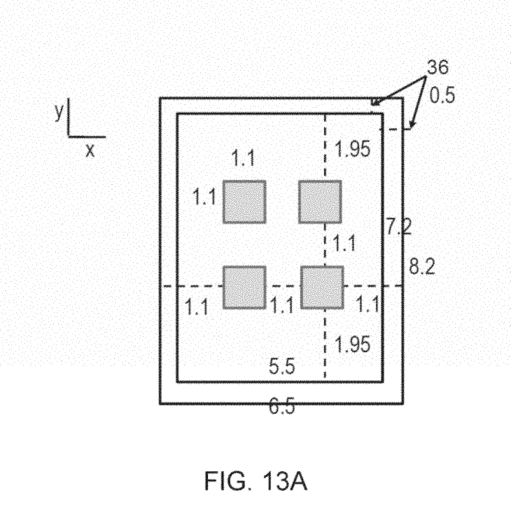

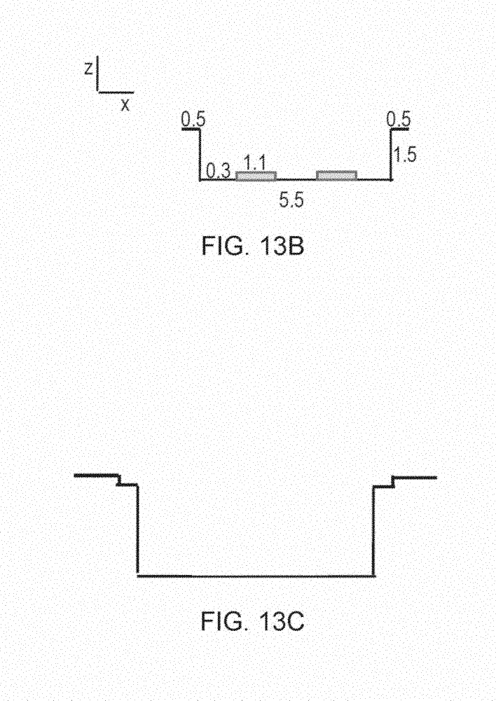

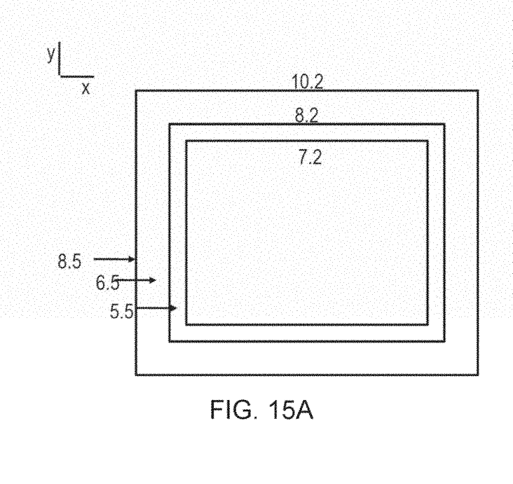

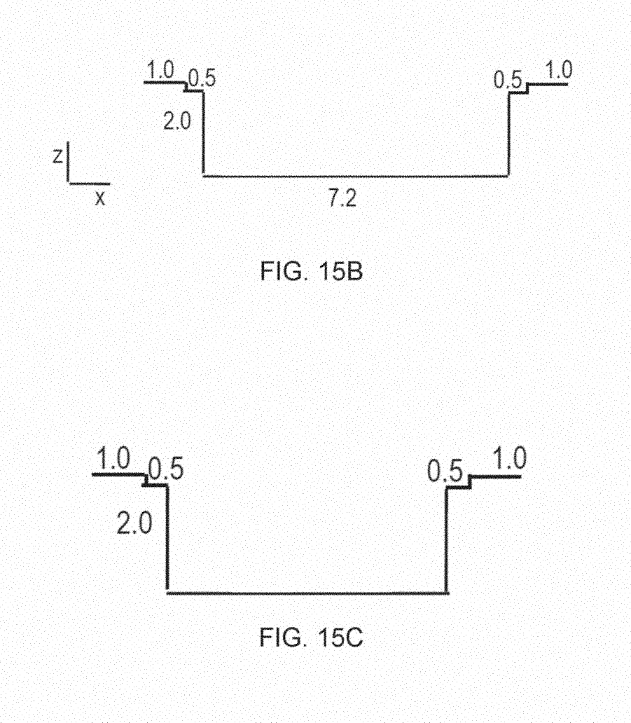

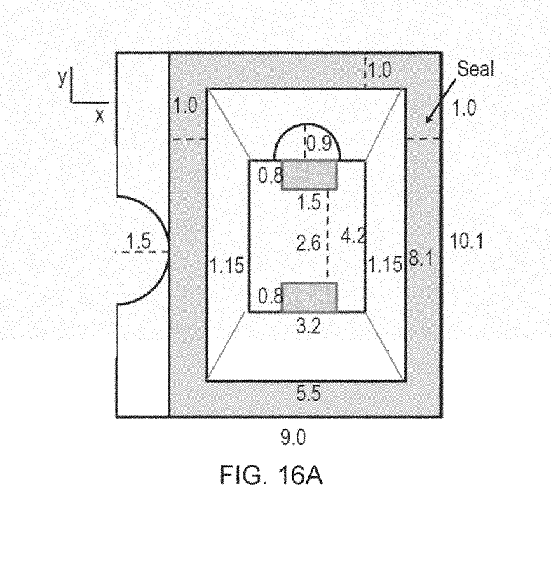

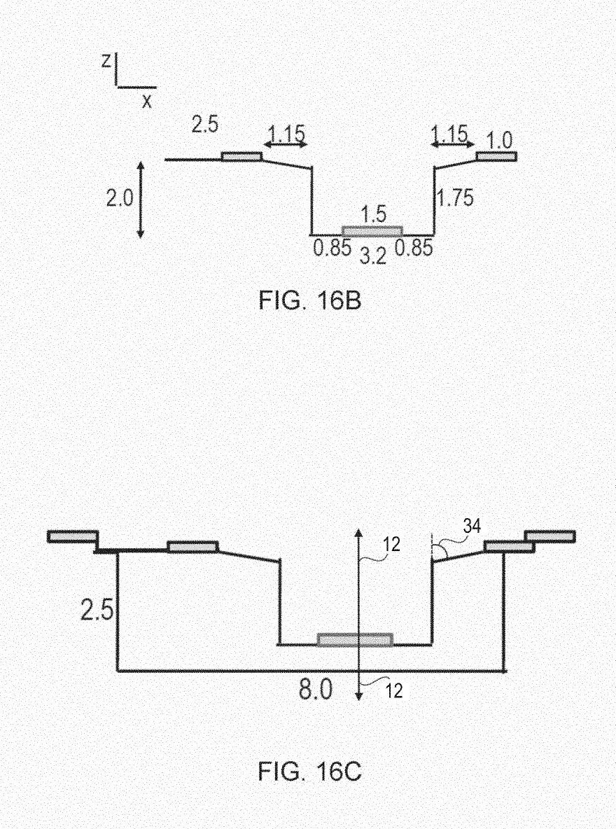

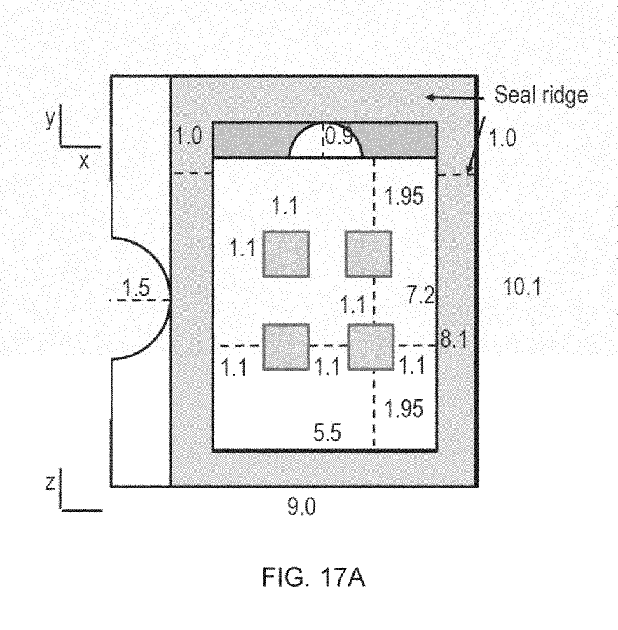

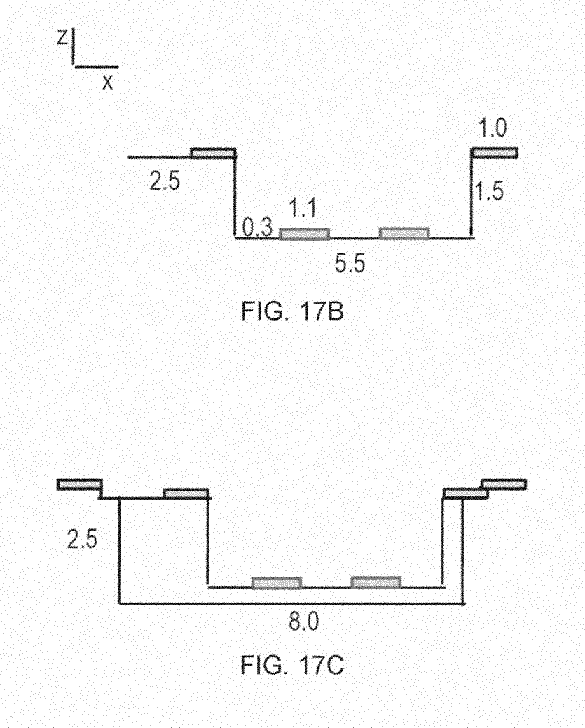

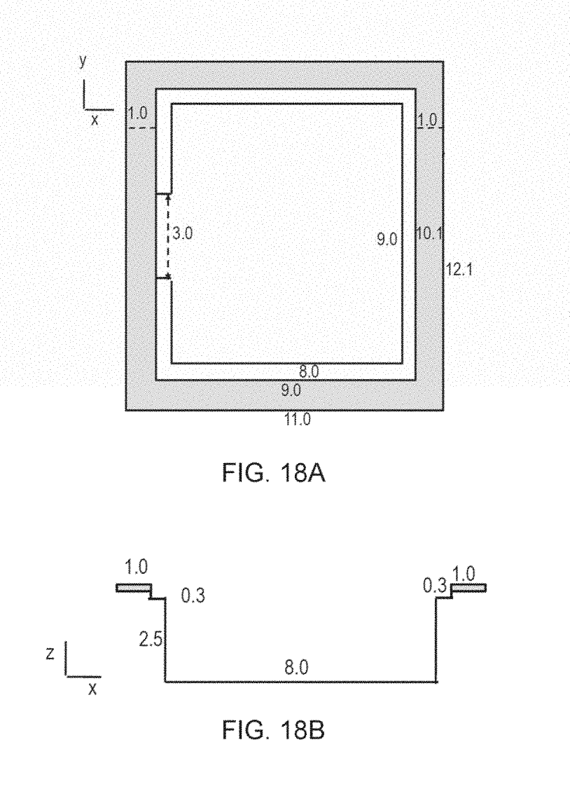

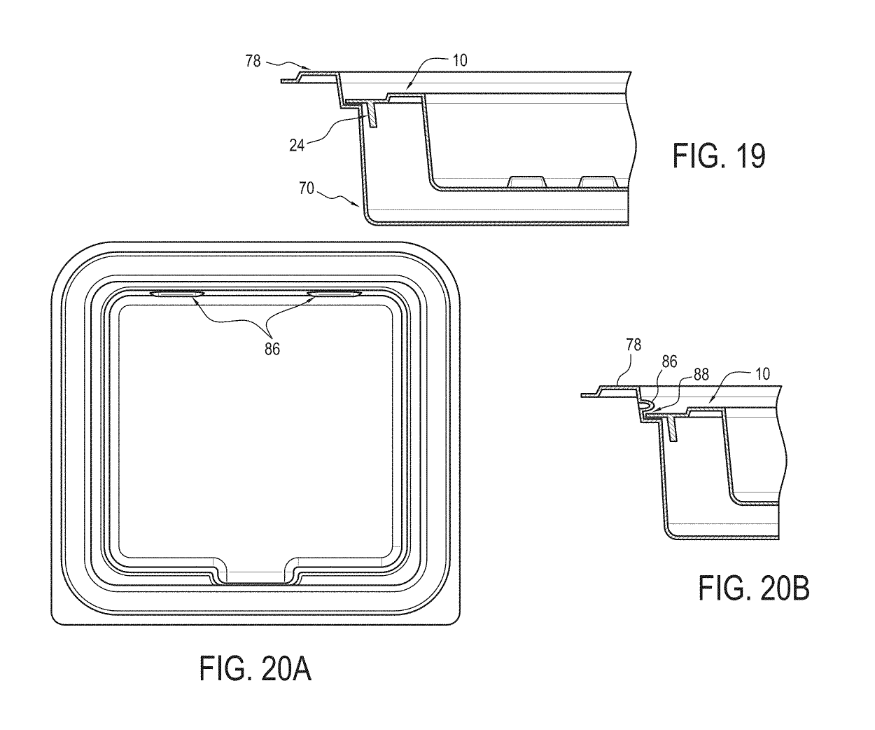

Disclosed herein, in various aspects and with reference to FIGS. 1A-20B, is a sealable tray system 150 for sealing a product 200 in a transport-ready position. As used herein, the term “transport-ready position” refers to a position of the product within the sealable tray system that is suitable for transport of the product as further disclosed herein. In exemplary aspects, and as further disclosed herein, the sealable tray system 150 can comprise an insert 10, a first lid 60, an outer basin 70, and a second lid 110.

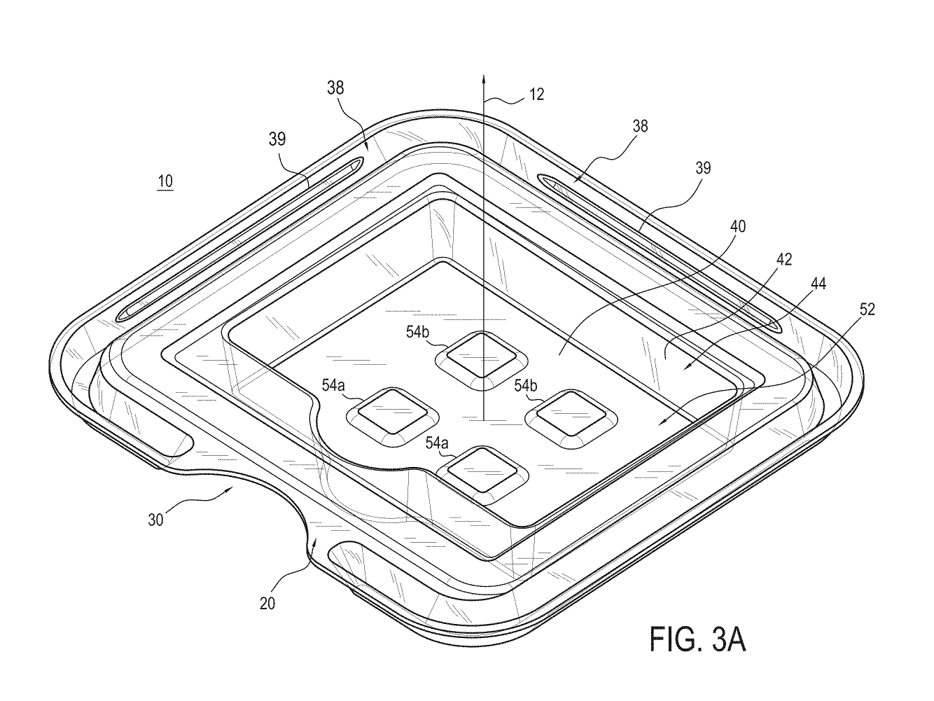

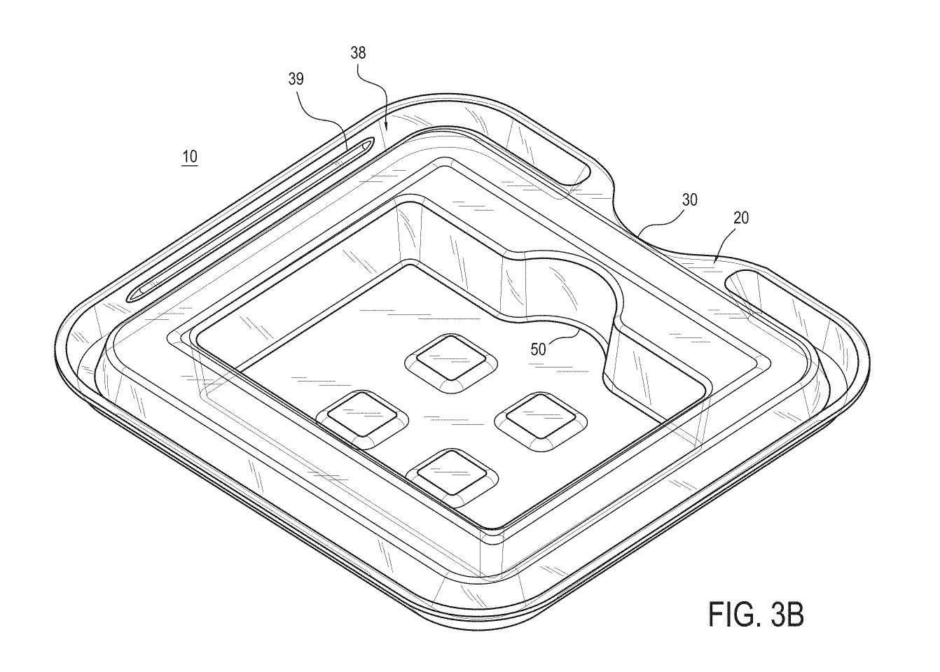

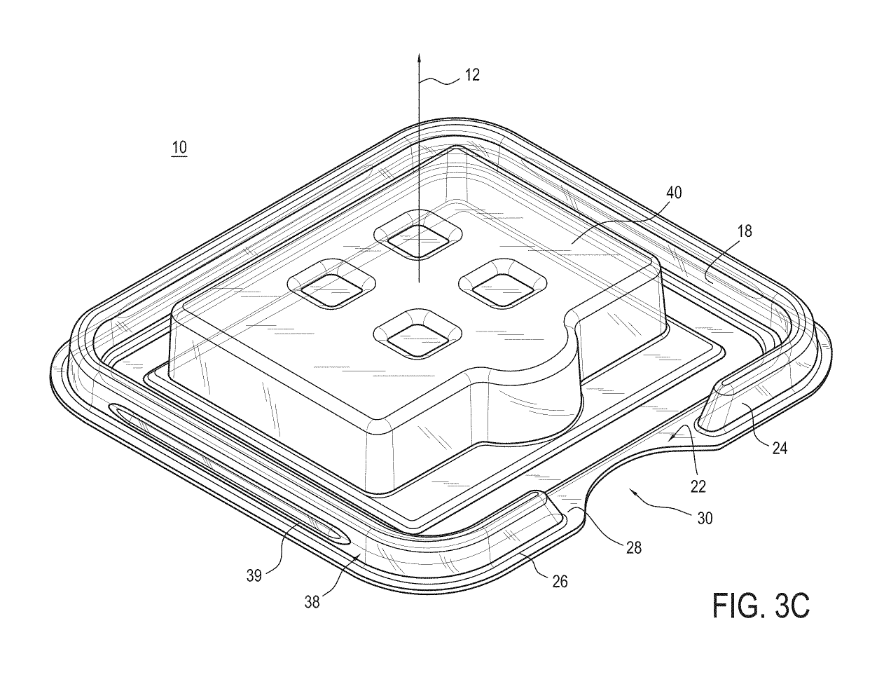

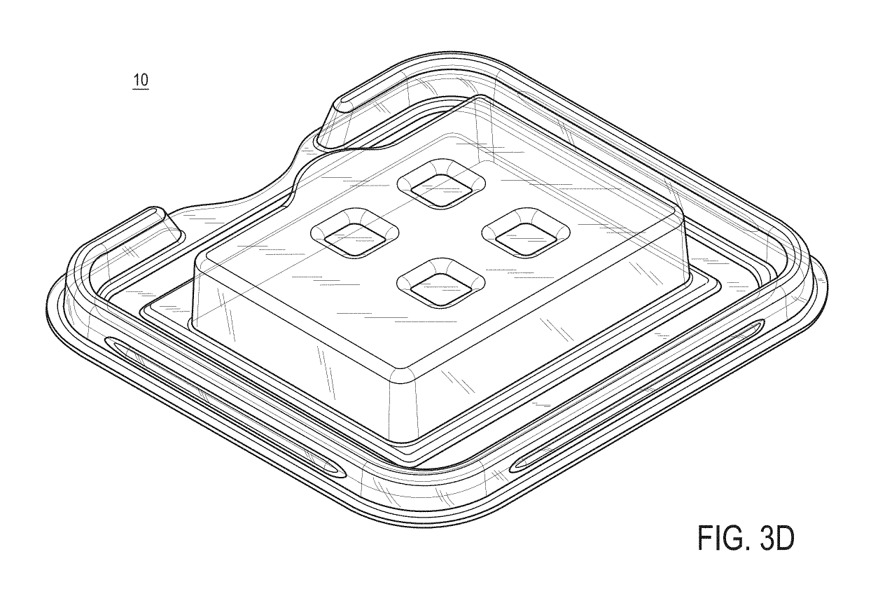

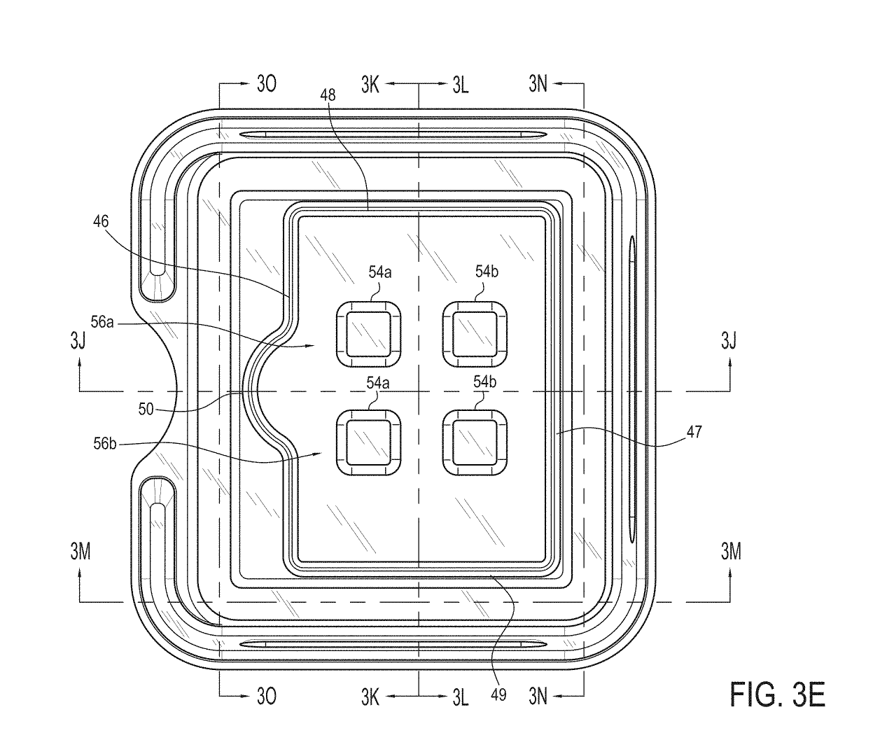

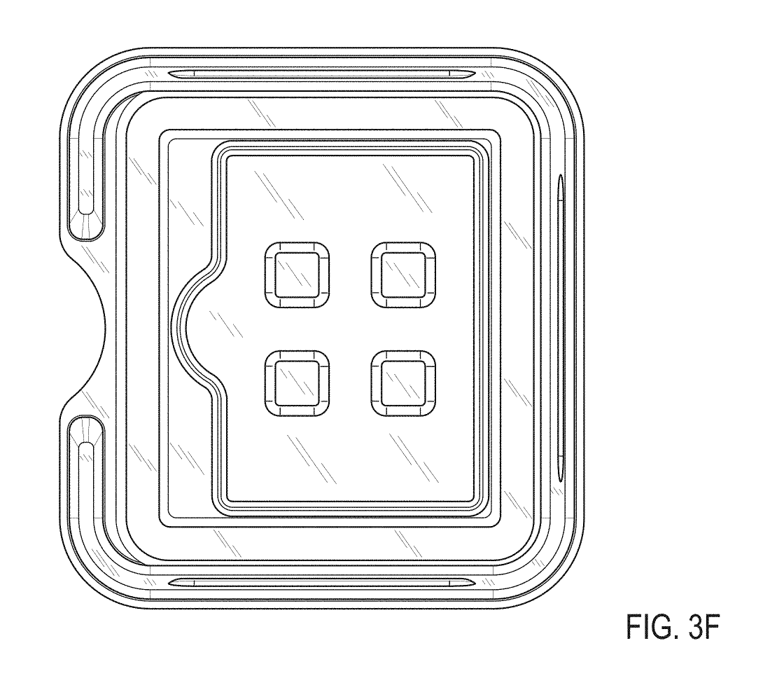

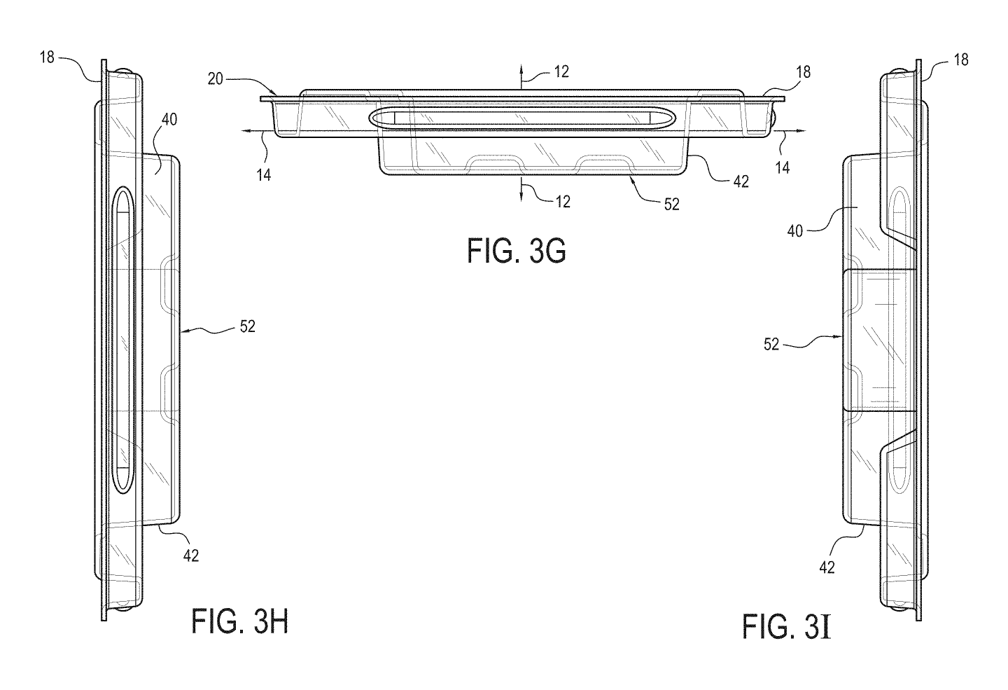

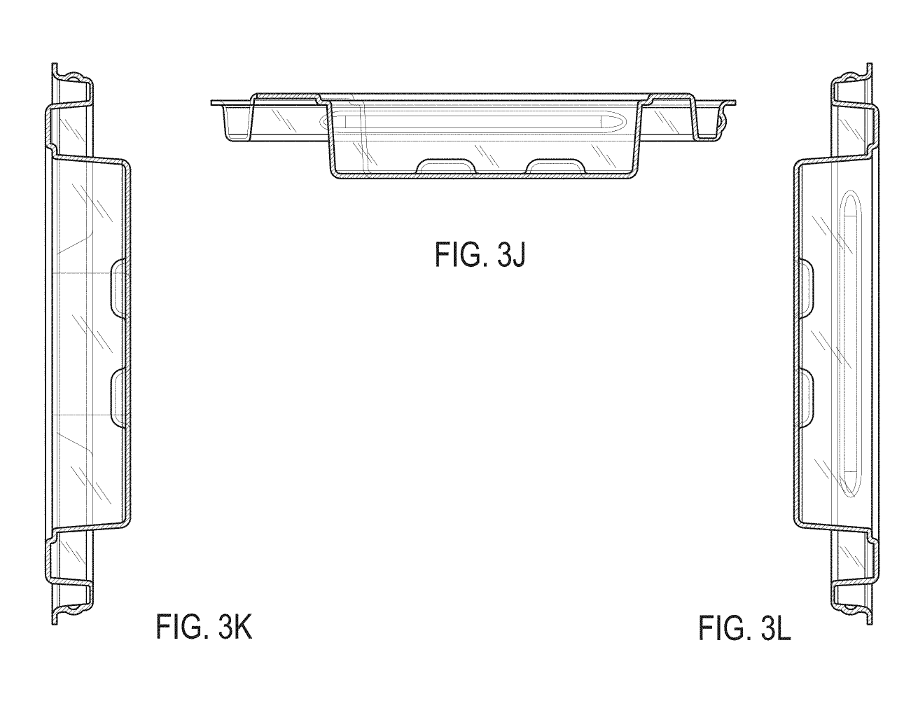

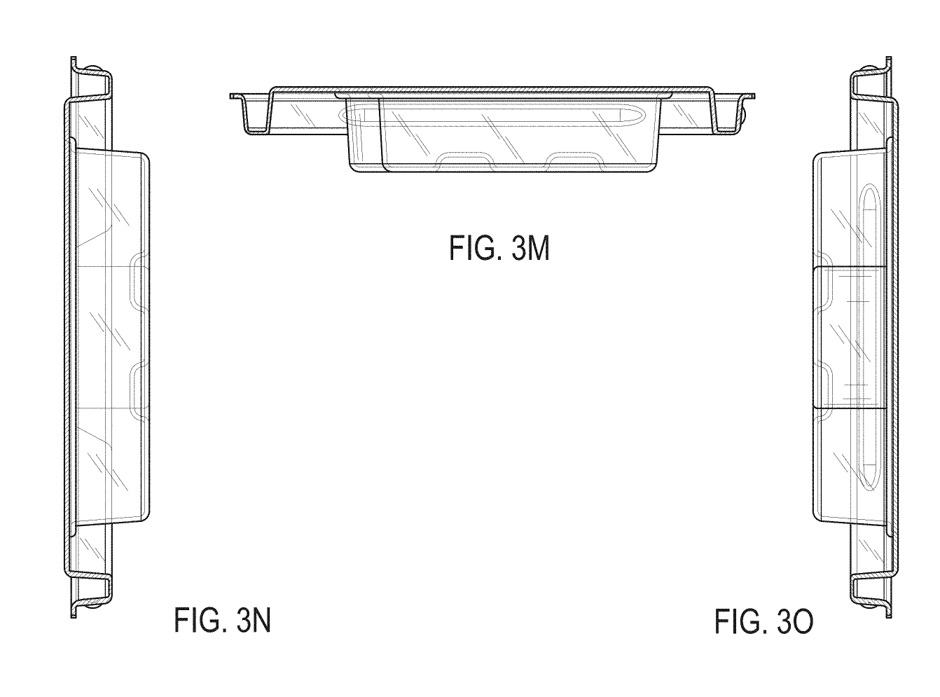

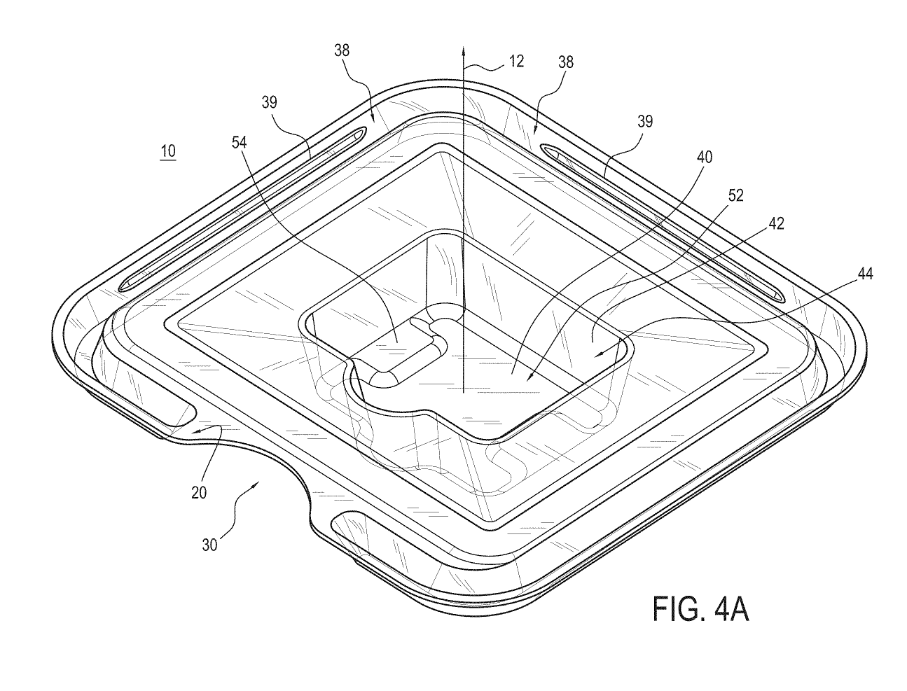

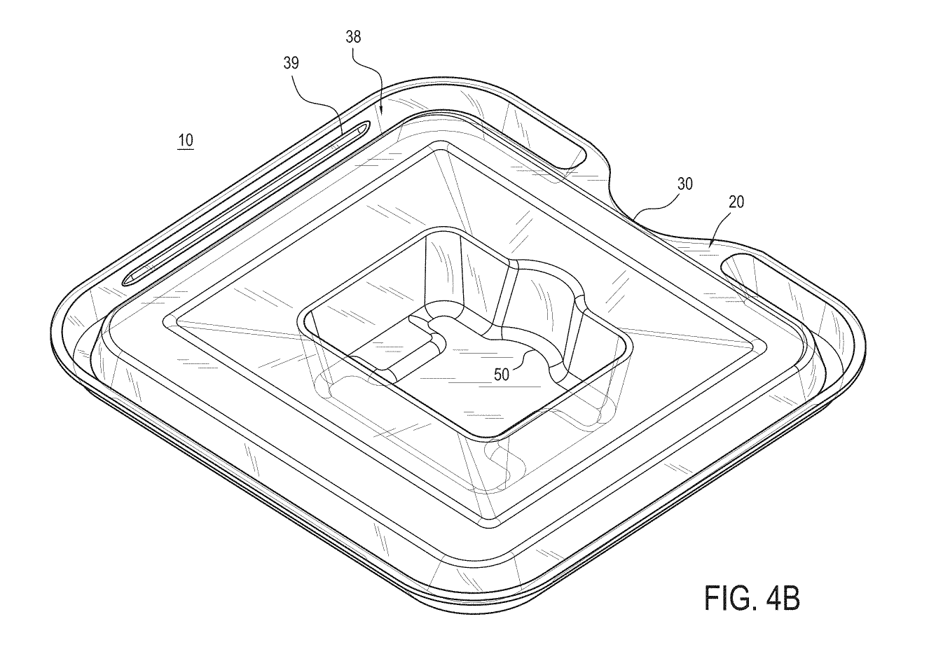

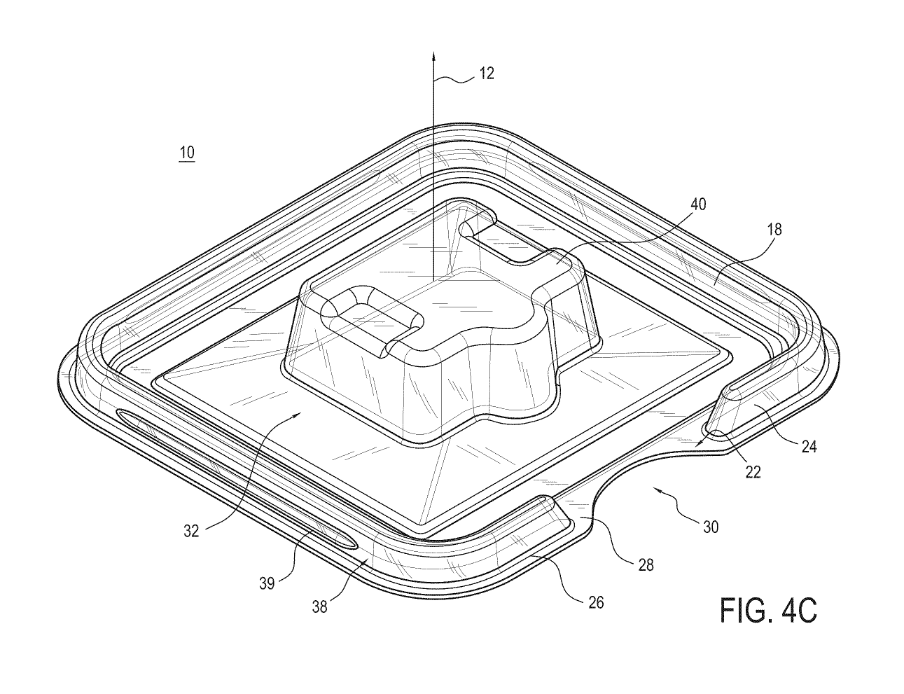

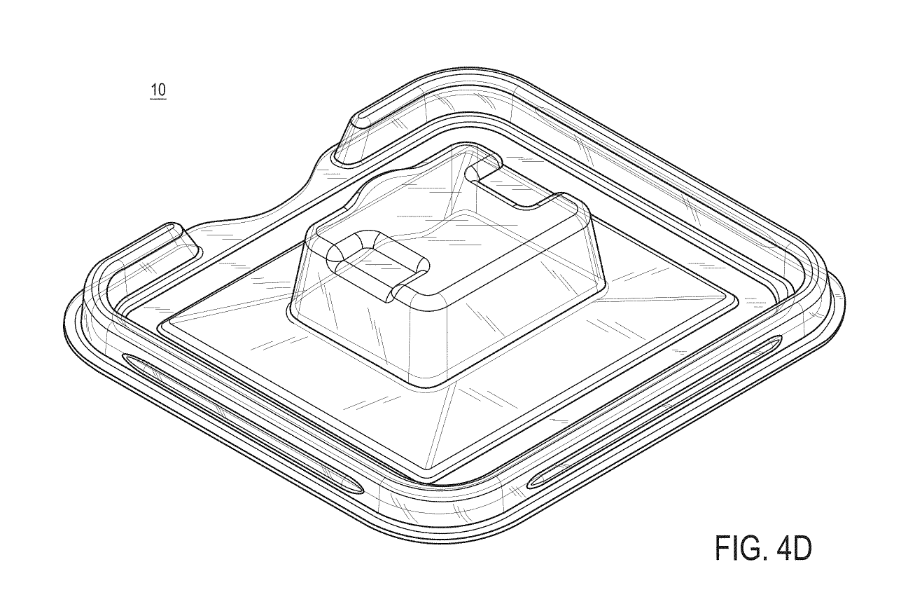

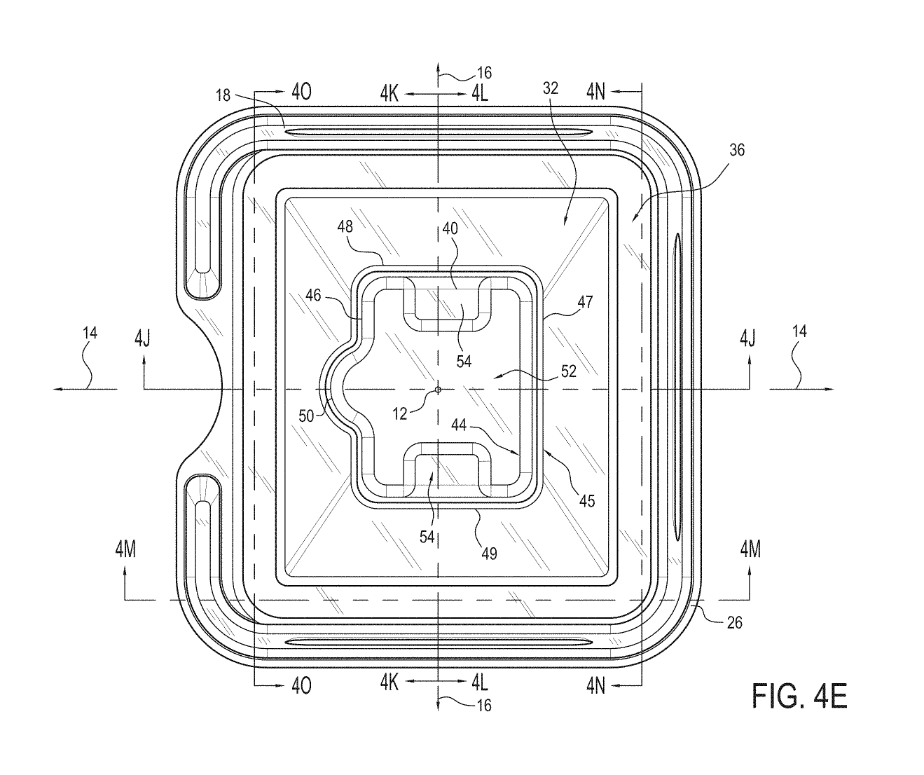

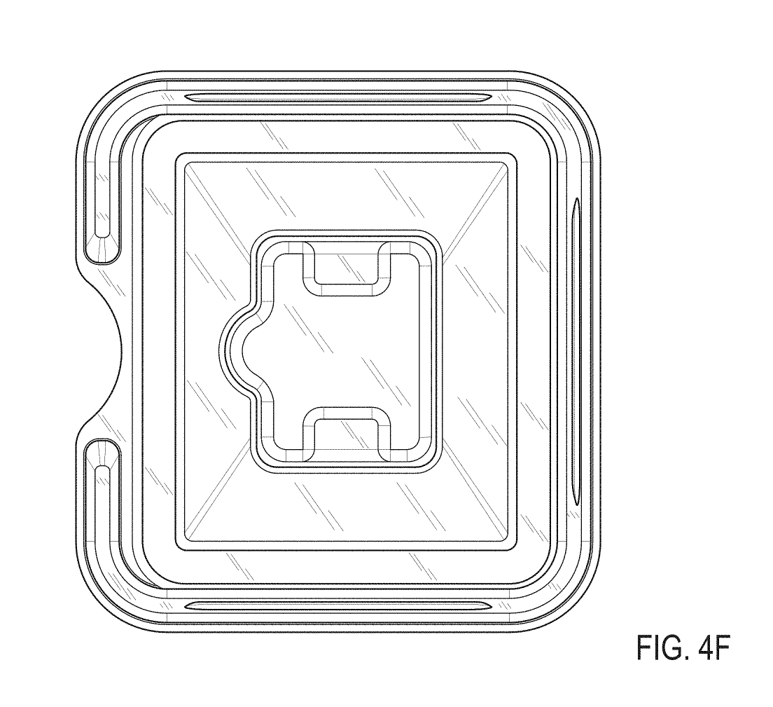

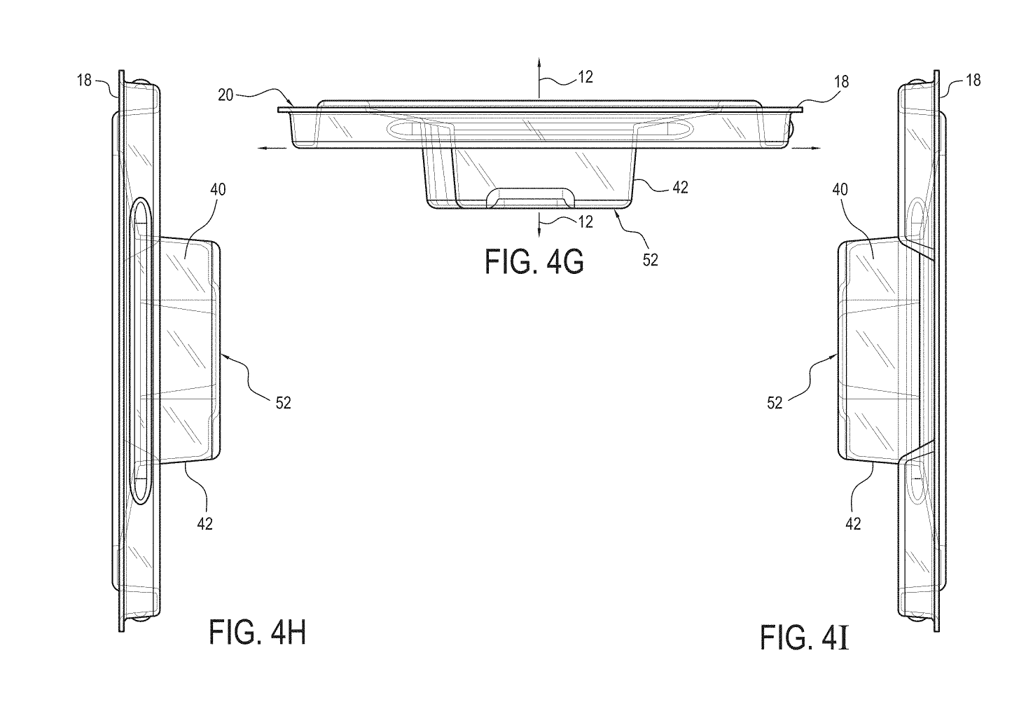

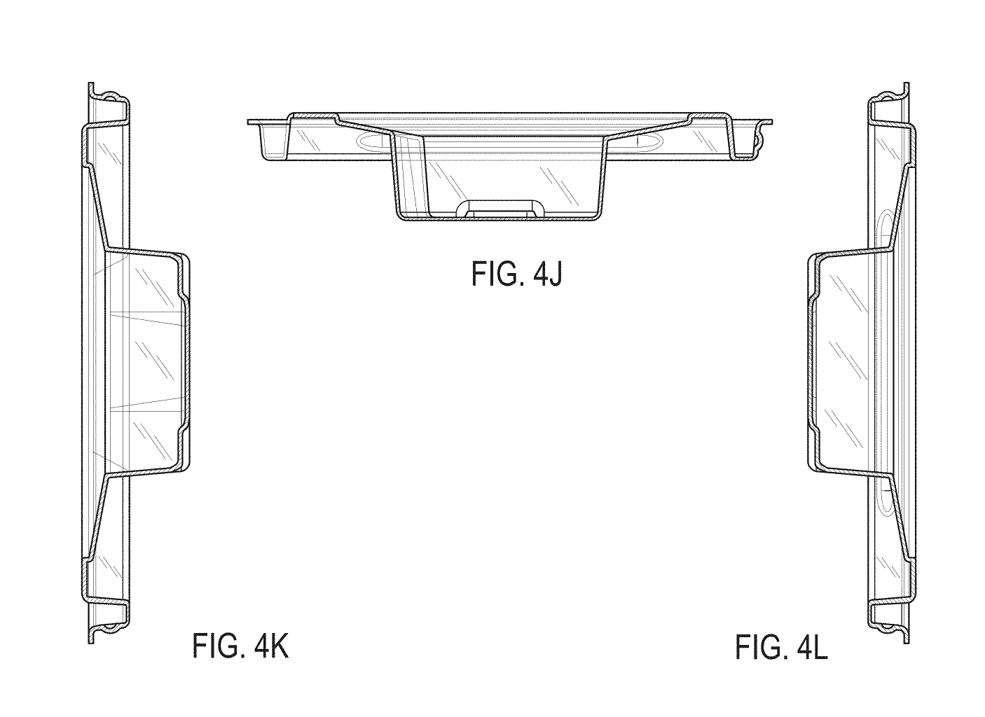

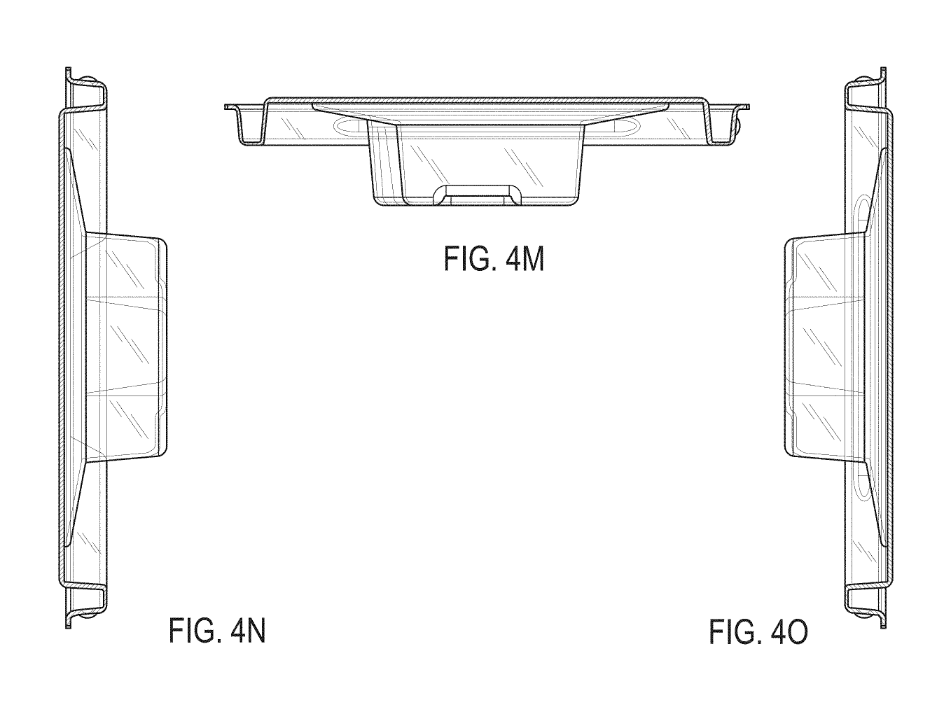

In one aspect, and with reference to FIGS. 3A-4O, the insert 10 can have a central axis 12, a flange portion 18, and a well portion 40. In this aspect, the flange portion 18 can have a top surface 20 and a bottom surface 22, and the well portion 40 can have a side wall 42 and a base surface 52. The side wall 42 can be connected to and extend between the flange portion 18 of the insert 10 and the base surface 52 of the well portion 40. The side wall 42 can have an inner surface 44 and an outer surface 45, and the base surface 52 of the well portion 40 can define at least one projection 54 that extends upwardly relative to the central axis 12 of the insert 10 and is configured to support the product 200. In exemplary aspects, the flange portion 18 can extend radially outwardly from the outer surface 45 of the side wall 42 of the well portion 40 relative to the central axis 12 of the insert 10. In another aspect, the first lid 60 can be configured to sealingly engage the top surface 20 of the flange portion 18 of the insert 10.

In an additional aspect, and with reference to FIGS. 1A-1L and 6-7, the outer basin 70 can be configured to receive the insert 10 in the transport-ready position. In this aspect, the outer basin 70 can have a central axis 72, a flange portion 74, a ledge portion 80, a base surface 90, and a side wall 92. The flange portion 74 can define a top surface 76 of the outer basin 70, and the side wall 92 of the outer basin can have an inner surface 94 and an outer surface 100 and can be connected to and extend upwardly from the base surface 90 of the outer basin relative to the central axis 12 of the outer basin. The ledge portion 80 of the outer basin 70 can be connected to and extend between the flange portion 74 and the side wall 92, and the flange portion can extend radially outwardly from the ledge portion 80 relative to the central axis 72 of the outer basin. The ledge portion 80 of the outer basin 70 can define a ledge surface 82. In exemplary aspects, the ledge surface 82 can be recessed from the top surface 76 of the outer basin 70 relative to the central axis 72 and extend radially inwardly from the flange portion 74 relative to the central axis. In another aspect, the second lid 110 can be configured to sealingly engage the top surface 76 of the outer basin 70.

In operation, it is contemplated that the outer basin 70 can serve as a protective barrier for all products positioned within an insert 10 as disclosed herein, particularly during transport of the product. When the product within the insert 10 is a frozen product (e.g., a frozen tissue product), it is contemplated that the outer basin 70 can be configured to dampen heat transfer to thereby slow the rate of cooling during freezing of the product and slow the rate of thawing at an end-user location. It is further contemplated that the outer basin 70 can optionally serve as a wash basin that can receive a washing solution and permit transfer of a thawed product from cryoprotectant solution within the insert 10 to the washing solution within the outer basin.

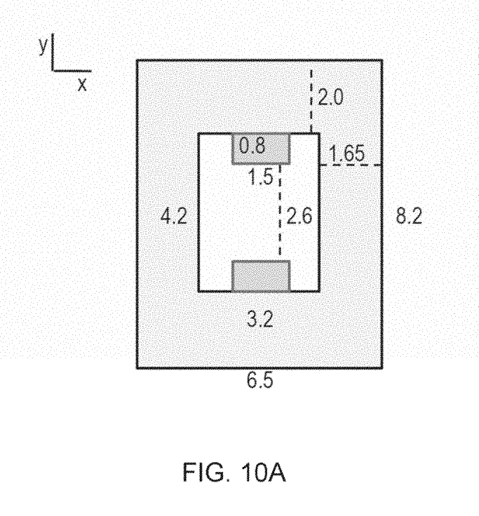

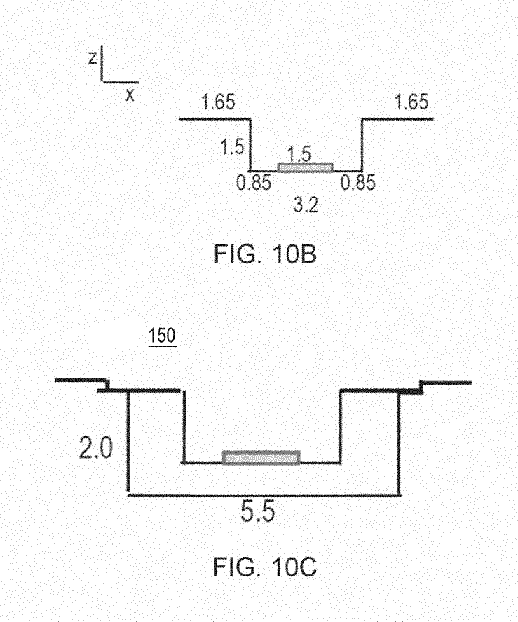

In a further aspect, the ledge surface 82 of the outer basin 70 can be configured for engagement with the bottom surface 22 of the flange portion 18 of the insert 10 to support the insert in the transport-ready position. Optionally, in this aspect, and as shown in FIGS. 10C, 16C, 17C, 19, and 20A-20B, the ledge surface 82 of the outer basin can be recessed relative to at least a portion of the flange portion 74 of the outer basin 70 (for example, ridge 78 as further described below) such that the first lid is positioned below the second lid by a desired distance, which, in exemplary non-limiting aspects, can be about 0.3 cm. In exemplary aspects, it is contemplated that the total height of the outer basin 70 (and thus, the entire sealable tray system 150) can be less than about 3.1 cm.

In exemplary aspects, the top surface 76 of the outer basin 70 can define at least one ridge 78 that projects upwardly from the top surface of the outer basin relative to the central axis 72 of the outer basin. In these aspects, the at least one ridge 78 can be configured to cooperate with the second lid 110 to form a seal over the insert 10. Optionally, it is contemplated that each ridge 78 of the at least one ridge can have a depth ranging from about 0.5 cm to about 0.7 cm and a width of about 0.2 cm.

In additional aspects, the ledge portion 80 of the outer basin 70 can optionally comprise a wall surface 84 extending downwardly from the top surface 76 of the outer basin relative to the central axis 72 of the outer basin. In these aspects, the ledge surface 82 of the ledge portion 80 can extend radially inwardly from the wall surface 84 relative to the central axis 72 of the outer basin 70. It is contemplated that the wall surface 84 of the ledge portion 80 can define at least one radial projection 86 spaced from the ledge surface 82 relative to the central axis 72 of the outer basin 70, as shown in FIGS. 20A-20B. Alternatively, it is contemplated that the side wall 92 can define the least one radial projection 86, as shown in FIGS. 1A-1F. In operation, it is contemplated that the at least one radial projection 86 can provide additional stability to the insert 10 during thawing procedures. Optionally, in exemplary aspects, each radial projection 86 can have a length (in the radial direction) of about 1.0 cm or another length that is slightly less than the width of the ledge surface 82 of the ledge portion 80 of the outer basin 70.

In further aspects, the at least one radial projection 86 and the ledge surface 82 of the ledge portion 80 of the outer basin 70 can cooperate to define a receiving space 88. In these aspects, the receiving space 88 can be configured to receive an outer portion 26 of the flange portion 18 of the insert 10.

In other aspects, the bottom surface 22 of the flange portion 18 of the insert 10 can define at least one stabilizing projection 24 extending downwardly from the bottom surface 22 of the flange portion relative to the central axis 12 of the insert. In these aspects, the at least one stabilizing projection 24 can be configured to restrict radial movement of the insert 10 relative to the central axis 12 of the insert. Optionally, in exemplary aspects, it is contemplated that the at least one stabilizing projection 24 of the insert 10 can comprise a wall surface 38 extending downwardly from the bottom surface 22 of the flange portion 18 relative to the central axis 12 of the insert. In these aspects, the wall surface 38 of the stabilizing projection 24 can define at least one radial projection 39 extending radially outwardly from the stabilizing projection 24 and spaced from the bottom surface 22 of the flange portion 18 relative to the central axis 12 of the outer basin 10, as shown in FIGS. 3A-3D and 4A-4D. In operation, it is contemplated that the at least one radial projection 39 can provide additional stability to the insert 10 during thawing procedures. Optionally, each radial projection 39 can have a length (in the radial direction) of about 1.0 cm or another length that is slightly less than the width of the ledge surface 82 of the ledge portion 80 of the outer basin 70.

In still further aspects, the top surface 20 of the flange portion 18 of the insert 10 can define at least one ridge 21. In these aspects, the at least one ridge 21 can project upwardly from the top surface 20 of the flange portion 18 relative to the central axis 12 of the insert 10. The at least one ridge 21 can be configured to cooperate with the first lid 60 to form a seal over the well portion 40 of the insert 10.

In exemplary aspects, the inner surface 94 of the side wall 92 of the outer basin 70 can have a first side 96 that defines a radially recessed portion 98 of the side wall of the outer basin. In these aspects, the inner surface 44 of the side wall 42 of the well portion 40 of the insert 10 can have a first side 46 that defines a radially recessed portion 50 of the side wall 42 of the well portion 40 of the insert. In operation, the radially recessed portion 98 of the side wall 92 of the outer basin 70 can be positioned in substantial alignment with the radially recessed portion 50 of the side wall 42 of the well portion 40 of the insert 10 when the insert is positioned in the transport-ready position. It is contemplated that the radially recessed portion 50 of the side wall 42 of the well portion 40 of the insert 10 can be configured to permit easy removal of a product positioned within the well portion. For example, the radially recessed portion 50 can provide additional space in communication with the well portion for positioning a finger or instrument underneath a product within the well portion. It is further contemplated that the radially recessed portion 98 of the side wall 92 of the outer basin 70 can be configured to permit easy removal of the second lid 110 by creating clearance for a finger or instrument to be positioned underneath the second lid. Optionally, in further exemplary aspects, the flange portion 18 of the insert 10 can have a first side 28 that defines a notch 30 positioned in substantial alignment with the radially recessed portion 50 of the side wall 42 of the well portion 40 of the insert 10. In these aspects, it is contemplated that the notch 30 can be configured to permit easy removal of the first lid 60 by creating clearance for a finger or instrument to be positioned underneath the first lid. Thus, in exemplary aspects in which the notch 30 and radially recessed portions 50 and 98 are positioned in substantial alignment, it is contemplated that a user can access and remove a product within the insert from a single position.

In other optional aspects, the inner surface 44 of the side wall 42 of the well portion 40 of the insert 10 can have a second side 47 opposed from the first side 46 and third and fourth sides 48, 49 that extend between the first and second sides 46, 47. In these aspects, the third side 48 can be opposed from the fourth side 49.

In one exemplary aspect, the at least one projection 54 of the base surface 52 of the insert 10 can comprise first and second projections 54a, 54b. In this aspect, the first projection 54a can be positioned proximate the third side 48 of the inner surface 44 of the side wall 42 of the well portion 40 of the insert 10, and the second projection 54b can be positioned proximate the fourth side 49 of the inner surface 44 of the side wall 42 of the well portion of the insert. In further exemplary aspects, the first projection 54a can extend radially inwardly from the third side 48 of the inner surface 44 of the side wall 42 of the well portion 40 of the insert 10 relative to the central axis 12 of the insert. In these aspects, the second projection 54b can extend radially inwardly from the fourth side 49 of the inner surface 44 of the side wall 42 of the well portion 40 of the insert 10 relative to the central axis 12 of the insert. In exemplary aspects, and with reference to FIGS. 4A-4F, the first and second projections 54a, 54b can have a rectangular or substantially rectangular cross-sectional shape.

In alternative exemplary aspects, the at least one projection 54 of the base surface 52 of the insert 10 can comprise a first row 56a of at least two spaced projections 54 and a second row 56b of at least two spaced projections. In further aspects, the projections 54 of the first row 56a of at least two spaced projections can be spaced apart relative to a first transverse axis 14. In these aspects, the projections 54 of the second row 56b of at least two spaced projections can be spaced apart relative to the first transverse axis 14. In another aspect, the first row 56a of at least two spaced projections can be spaced from the second row 56b of at least two spaced projections relative to a second transverse axis 16 that is perpendicular or substantially perpendicular to the first transverse axis 14 and the central axis 12. In additional aspects, the first row 56a of at least two spaced projections can be spaced from the third side 48 by a selected distance relative to the second transverse axis 16, and the second row 56b of at least two spaced projections can be spaced from the fourth wall 49 by the selected distance relative to the second transverse axis 16. In further aspects, the first and second rows 56a, 56b of at least two spaced projections can comprise first and second spaced projections 54a, 54b. In exemplary aspects, and with reference to FIGS. 3A-3F, it is contemplated that the projections of the first and second rows 56a, 56b can have square or substantially square cross-sectional shapes.

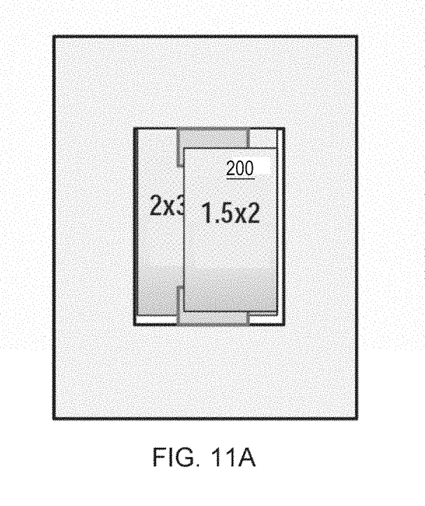

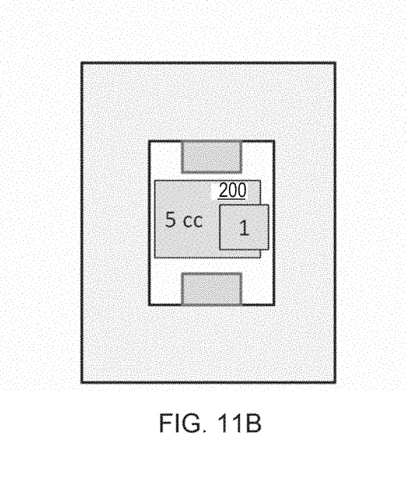

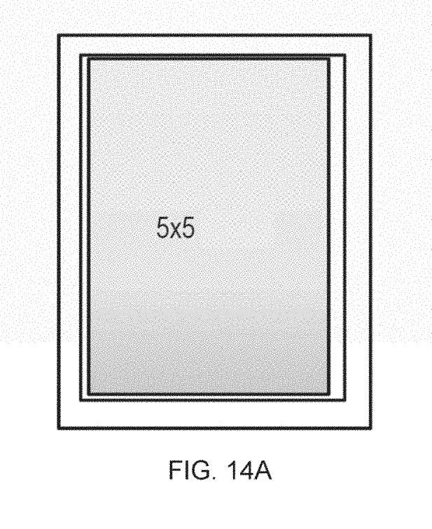

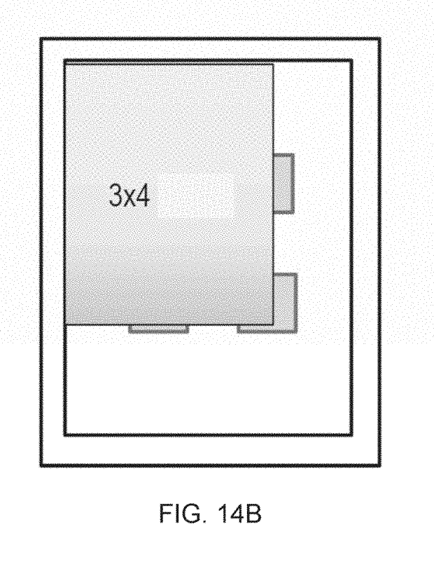

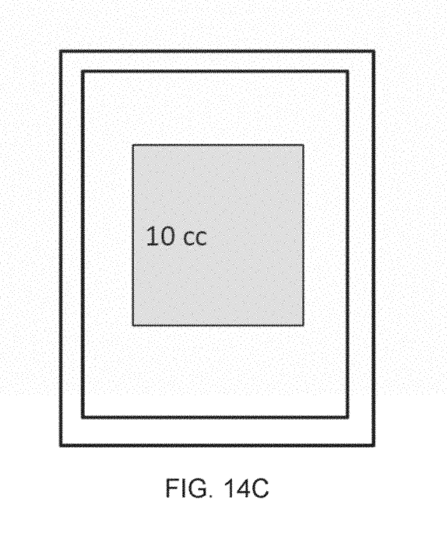

In operation, and with reference to FIGS. 11A and 14A-14C, it is contemplated that the projections 54 within the well portion 40 of the insert 10 can be configured to support products of various sizes in a flat orientation that is horizontal or substantially horizontal or parallel to the surface upon which the outer basin rests or insert rests. As shown in FIGS. 11B-11C, it is further contemplated that the bottom of the well portion 40 (e.g., the portion of the well between the projections 54) can be configured to receive and support products of various sizes. It is still further contemplated that the projections 54 disclosed herein can be configured to ensure more complete coverage of products with cryoprotectant than conventional packaging assemblies.

In exemplary aspects, the flange portion 18 of the insert can have a sloped surface 32 and a lip 36. In these aspects, the sloped surface 32 of the flange portion 18 of the insert 10 can extend between the lip 36 of the flange portion and the side wall 42 of the well portion 40 of the insert. The lip 36 of the flange portion 18 of the insert 10 can extend radially outwardly from the sloped surface 32 of the flange portion relative to the central axis 12 of the insert, and the lip of the flange portion can define the top surface 20 and the bottom surface 22 of the flange portion of the insert. In further exemplary aspects, the sloped surface 32 of the flange portion 18 of the insert 10 can extend between the side wall 42 of the well portion of the insert and the lip 36 of the flange portion 18 of the insert at a selected angle 34 relative to the central axis 12 of the insert. In still further exemplary aspects, the selected angle 34 can range from about 45 degrees to about 90 degrees. In still further exemplary aspects, the selected angle 34 can be less than about 90 degrees or, optionally, less than about 85 degrees. In use, it is contemplated that the sloped surface 32 can be configured to prevent cryoprotectant solution from collecting and/or freezing outside of the well portion 40 of the insert 10, thereby keeping the solution away from the seal formed between the first seal and the insert.

In exemplary aspects, the outer basin, the first and second lids, and a plurality of inserts can be provided as a kit for sealing a product in a transport-ready position. In these aspects, it is contemplated that the outer dimensions of each insert of the plurality of inserts can be substantially the same and complementary to the inner dimensions of the outer basin. Optionally, it is contemplated that the plurality of inserts can comprise at least one insert having multiple rows of projections (for example, as shown in FIGS. 3A-3F) and at least one insert that does not have multiple rows of projections (for example, as shown in FIGS. 4A-4F).

In further exemplary aspects, it is contemplated that the insert, the outer basin, and the first and second lids can comprise a selected material or combination of materials. In further exemplary aspects, the selected material can be configured to maintain a sterile barrier and have sufficient resistance to puncturing. In still further exemplary aspects, it is contemplated that the selected material can be thermoformable. In still further exemplary aspects, it is contemplated that the selected material can be transparent or substantially transparent. Alternatively, it is also contemplated that the selected material can be opaque or substantially opaque.

In some aspects, the insert, the outer basin, and the first and second lids can comprise any compatible substrate for the practice of the present technology, preferably a biocompatible substrate. The substrate can provide structural integrity or support to the products 200 for handling during any of the phases described herein (e.g., manufacture, storage, transport and/or final application). In some instances, the substrate may be a suitable composition that is not chemically or physically altered by cryopreservation solutions (for example, solutions containing Dimethyl Sulfoxide (DMSO). In some aspects, the substrate is also not chemically or physically altered by abrupt or large changes in temperature, and can be used within a wide temperature range (e.g., −196° C. to 60° C.±5° C.). In other embodiments, the substrates are made of polymers, copolymers, or biocompatible materials (e.g., plastics) that are thermal compatible and compatible with use with cryopreservation solutions. Suitable plastics include, but are not limited to, low density polyethylene (LDPE), high density polyethylene (HDPE), ECTFE or ETFE copolymer (Ethylene ChloroTriFluoroEthylene or Ethylene tetrafluoroethylene) FEP (fluorinated ethylene propylene), PE (Polyethylene) PP (Polypropylene), PMP (Polymethylpentene), Teflon®, PS (Polystyrene), RESMER™ (also known as RESMER Manufacturing Technology commercially available from Thomas Scientific of Swedesboro, N.J.), EVA, among others. However, it should be appreciated by those skilled in the art that in those embodiments of the present technology in which a cryopreservation media is not utilized, other suitable substrates are envisaged in the practice of the present technology. In one exemplary aspect, at least the insert and the outer basin can comprise Eastman Tritan copolyester MP100. Optionally, in this aspect, it is contemplated that the first and second lids can likewise comprise Eastman Tritan copolyester MP100.

In further embodiments of the present technology, the components of the disclosed sealable tray system can comprise a material suitable for use with biological or cellular materials, for example, a bio- or cellular-compatible plastic. The plastic may be a composite of different plastics or a homogenous plastic composition. Further such plastics may be combinations of plastics, layers of one or more types of plastics, among other plastics combinations. Again, preferably, the plastics utilized in the practice of the present technology are biocompatible plastics that are further preferably, made of medical grade quality. It is also preferable that the substrates used in the practice of the present technology should be capable of withstanding a wide range of temperature changes ranging from about 40° C.±5° C. to about −196° C.±5° C., preferably from about 40° C.±5° C. to about −80° C.±5° C. The substrates should be capable of withstanding freezing temperature from about −80° C.±5° C. to about −196° C.±5° C. Substrates should also be capable of remaining at about room temperature (about 20° C. to about 25° C.±5° C.), during refrigeration (about 4° C. to about 8° C.±5° C.), and during freezing (from about −20° C.±5° C. to about −196° C.+/−5° C.), alternatively from about −45° C. to about −50° C.+5° C., alternatively from about −80° C. to about −196° C.±5° C. For substrates used with cellular membranes, the substrates should be capable of withstanding a wide range of temperatures from about 60° C. to about −196° C. (±5° C.). Suitable biocompatible plastics may include, but are not limited to plastics that withstand exposure to a cryopreservation solution and/or membrane, tissue, graft or other biological material(s) without chemical alteration of its composition and/or alternatively, damaging, injuring, or otherwise harming the membrane (tissue, graft, or other biological material(s)), including harming viable cells associated therewith. Suitable biocompatible plastics can also include, for example, plastics capable for use in 3-D printing applications or manufacturing procedures.

As provided herein, it should be appreciated that the products 200 used with the present technology can, in exemplary non-limiting aspects, comprise biological products, including membranes, tissues, grafts, and other biological materials. The term “membrane” or “membranes” shall be used expansively throughout the instant specification to encompass various cellular and/or biological materials suitable for use in the practice of the present technology. It should also be appreciated by those skilled in the art that “membrane” or “membranes” of the present technology can comprise natural “membranes”, synthetic “membranes” or combinations or derivatives thereof. For example, natural membranes can include but are not limited to grafts, naturally derived membranes, and bioengineered membranes comprising living cells, further including, but not limited to, placental membranes, skin grafts, in vitro cultured grafts, tendon grafts, among others. Natural membrane may include allografts, autografts or xenografts. Natural membranes may be derived from mammals, including, for example humans. Bioengineered membranes can include living cells, extracellular matrix, biomolecules, at least one type of cytokine, and combinations or derivatives thereof. Based on the structure of the bioengineered membranes, other suitable materials or biomolecules may be associated with the membrane. Other natural membranes may include, for example, at least one natural fiber, for example, silks. Further non-natural or synthetic membranes, for example, can include but are not limited to membranes containing at least one synthetic fiber or compound, such as nylon, copolymers, polymers, including, but not limited to, PVA (polyvinyl acetate), PLA, (polylactic acid), PGA (polyglycolic acid), PCL (polycaptolactone), PLGA (poly(lactic-co-glycolic) acid), polyglactin, and the like. Further, it should be appreciated that suitable membranes can also include chorionic membrane products, amniotic membrane products, combinations thereof and other placental membrane products. Placental membranes products that can be used with the present technology are disclosed in U.S. application Ser. No. 13/030,507 (Publication No. 2011/0212158); Ser. No. 14/069,894 (Publication No. 2014/0140966); Ser. No. 14/070,035 (Publication No. 2014/0127317); Ser. No. 14/172,940 (Publication No. 2014/0294777); Ser. No. 14/056,101 (filed Oct. 17, 2013); Ser. No. 14/070,040 (Publication No. 2014/0127177); Ser. No. 14/272,343 (Publication No. 2015/0010609); and Ser. No. 14/291,256 (Publication No. 2014/0301986), in the name of Osiris Therapeutics, Inc. of Baltimore, Md., all of which are incorporated by reference in their entireties. Suitable amniotic membrane products include Grafix® Prime® (Osiris Therapeutics, Columbia, Md.). Suitable chorionic membrane products include, for example, Grafix® Core® (Osiris Therapeutics, Columbia, Md.).

Other exemplary graft products for use with the disclosed systems and methods include cartilage grafts and bone grafts. Suitable grafts for use in the practice of the present technology can also include, for example, grafts containing viable cells. Some suitable grafts, for example contain fibroblasts, epithelial cells, stem cells, mesenchymal stem cells, and compositions comprising various combinations thereof. In some embodiments, the compositions comprising viable fibroblasts and epithelial cells.

Suitable bioengineered grafts include grafts in which viable cells, for example fibroblasts, stem cells, epithelial cells, mesenchymal stem cells, which are seeded onto a synthetic or natural membrane. The cells are cultured to provide a sufficient membrane structure. Based on the structure of the bioengineered membranes, other suitable materials or biomolecules may be associated with the membrane. For example, bioengineered grafts may contain extracellular matrix, biomolecules including, but not limited to, cytokines, growth factors, co-stimulatory molecules, proteoglycans, and the like. In some instances, the bioengineered grafts may not include viable cells, and may include other biological membrane components, including, but not limited to, extracellular matrix (e.g., collagen, proteoglycans), biomolecules and the like.

In other exemplary non-limiting aspects, it is understood that the products 200 used with the disclosed systems and methods can comprise flowable products. In these aspects, and as further disclosed herein, it is contemplated that the products 200 can comprise syringes, vials or other receptacles that contain and permit dispensing of flowable materials.

As can be illustrated by the present technology it was surprisingly found that, the described compositions, devices, articles of manufacture and/or systems (e.g., the disclosed system 150) maintain the viability of the product within the insert. Such an outcome is advantageous as the present technology provides various packaging or packaging system embodiments that support, protect, contain and maintain live cells (e.g., naturally derived membranes or bioengineered membranes) for use in a variety of therapeutic, diagnostic, experimental and/or analytical applications/uses unlike the conventional packaging, packaging systems and non-living cellular packaging products of the prior art.

Further, the compositions, devices, and systems of the present technology also were surprisingly found to maintain the viability, reduce or prevent injury or damage and maintain an ease of removal and application of the cells in the products even during a variety of environmental stresses such as manufacturing, processing, cryopreservation, freezing, storage, thawing, transporting, and final application/use of such membranes (or cells). Such outcomes are advantageous for the support, stability and protection of cellular or biological products in a packaging or packaging system not envisaged by the conventional art.

Further, the compositions, devices, articles of manufacture and systems of the present technology may also maintain the integrity of the product during a variety of environmental stresses, such as, manufacturing, processing, cryopreservation, freezing, storage, thawing, transporting, and final application/use of such membranes (or cells).

Membrane products can be placed within the well portion of an insert in an operative position, which maintains the directionality of the membrane (e.g., epithelial cells or tissues on the cover and connective tissue cells or tissue on the base). It is contemplated that portions of the insert and/or first lid can be labeled to maintain the directionality with a marker or label. Maintaining directionality is important in cellular repair, especially when membranes which mimic the composition of the skin are used. For example, some membranes may have a first side and a second side, where the first and second sides have different compositions. For example, amniotic membranes derived from placental tissue have a first side containing stromal cells and a second side containing epithelial cells. For application as a wound or tissue defect repair composition, it is important to maintain the directionality of the membrane. The first side containing stromal cells should make direct contact with the tissue defect or wound, and the epithelial layer should face exterior to the wound, mimicking the structure of the epidermis.

Products utilized in the practice of the present technology may be any suitable size and customizable depending on the type of product and the particular end application or usage of that product. Suitable sizes (length×width) of product (e.g., membrane products) include, but are not limited to, about 1.5 cm×about 1.5 cm, about 2 cm×about 2 cm, about 3 cm×about 3 cm, about 4 cm×about 4 cm, about 5 cm×about 5 cm, about 6 cm×about 6 cm, about 7 cm×about 7 cm, about 8 cm×about 8 cm, about 7.5 cm×about 15 cm, about 1.5 cm×about 2 cm, about 1.5 cm×about 3 cm, about 2 cm×about 3 cm, about 3 cm×about 4 cm, about 2 cm×about 5 cm, about 3 cm×about 5 cm, about 4 cm×about 5 cm, about 5 cm×about 7 cm, about 5 cm×about 10 cm, about 5 cm×about 15 cm, and include any variations or sizes and ranges there between, in increment of 0.1 cm to 1 cm.

In some embodiments, the systems and/or kits disclosed herein can further comprise cryopreservation solution. The cryopreservation solution is added to the well portion of the insert containing the product. Preferably, a sufficient amount of cryopreservation solution is added to the well portion of the insert to protect the product during subsequent freezing steps. The projections of the insert allow for sufficient infusion of the product with the cryopreservation solution to maintain viability of the cells contained within the product. Suitable cryopreservation solutions are known in the art. In one embodiment, the cryopreservation comprises storage in a cryopreservation medium comprising one or more cell-permeating cryopreservatives, one or more non-cell permeating cryopreservatives, or a combination thereof. Suitable cryopreservatives include, but are not limited to, DMSO, a glycerol, a glycol, a propylene glycol, an ethylene glycol, propanediol, polyethylene glycol (PEG), 1,2-propanediol (PROH) or a combination thereof. In some embodiments, the cryopreservation solution may contain one or more non-cell permeating cryopreservative selected from polyvinyl pyrrolidione, a hydroxyethyl starch, a polysaccharide, a monosaccharide, an alginate, trehalose, raffinose, dextran, human serum albumin, ficoll, lipoproteins, polyvinyl pyrrolidone, hydroxyethyl strarch, autologous plasma or a combination thereof. Other examples of useful cryopreservatives are described in Cryopreservation (BioFiles, Volume 5, Number 4 Sigma-Aldrich® Datasheet).

For example, a suitable cryopreservation solution comprises a cryopreservative, in an amount of at least about 0.001% to 100%, suitably in an amount from about 2% to about 20%, preferably about 5% to about 10% by volume. In some instances, the cryopreservation solution comprises at least about 2% cryopreservative. Further, the cryopreservation solution may comprise serum albumin or other suitable proteins. In some embodiments, the cryopreservation solution comprises from about 1% to about 20% serum albumin or other suitable proteins, alternatively from about 1% to about 10%. Serum albumin or other suitable proteins are present to help stabilize the product during the freeze-thaw process and to reduce the damage to cells, maintaining viability. Serum albumin may be human serum albumin or bovine serum albumin. The cryopreservation solution may further comprise a physiological buffer or saline, for example, phosphate buffer saline.

The well portion of the insert is filled with sufficient amount of the cryopreservation solution to cover both sides of the membrane. The amount of the cryopreservation solution necessary will depend on the type of insert used and the size of the insert relative to the size of the product. The lower the amount of cryopreservation solution necessary to cover the composition/device, the faster the composition is able to thaw. Thus, it is desirable to use the least amount of cryopreservation solution that allows for top coverage of the product without compromising viability of the cells during the freeze thaw. Further, the smaller the product and the smaller the insert used, the less cryopreservation solution can be used.

In some embodiments an insert is used containing from about 7 ml to about 50 ml, alternatively from about 5 ml to about 20 ml, alternatively from about 7 ml to about 20 ml, alternatively from about 7 ml to about 15 ml. The amount of cryopreservation solution can be sufficient to fully submerge the product within the insert. The amount will depend on the size of the insert used and the size of the product being cryopreserved.

In some embodiments, the amount of cryopreservation solution is sufficient to protect cells during the freezing and subsequent thawing procedures. In some embodiments, at least 70% cell viability is maintained after a freeze-thaw. In some aspects, at least 75% cell viability is maintained, alternatively about 80% cell viability is maintained, alternatively 85% cell viability is maintained, alternatively about 90% cell viability is maintained, alternatively about 95% cell viability is maintained. In some embodiments, viability of the product is at least 70%, at least 71%, at least 72%, at least 73%, at least 74%, at least 75%, at least 75%, at least 78%, at least 80%, at least 82%, at least 85%, at least 88%, at least 89%, at least 90%, at least 92%, and percentages in between.

In some embodiments, the amount of cryopreservation solution is sufficient to protect the structural, architectural, and or 3-D structure of the product, including acellular matrixes. In some embodiments, the cryopreservation solution contains a cryopreservative in an amount of 0.01% to about 100%, alternatively from about 2% to about 100%. In some embodiments, the cryopreservation solution contains polysaccharides or monosaccharides.

In use, the disclosed sealable tray system can seal a product in a transport-ready position. In exemplary aspects, a method of sealing a product in a transport-ready position can comprise positioning the product within the insert of the sealable tray system. In another aspect, the method of sealing the product in the transport-ready position can comprise positioning a first lid over the well portion to seal the product within the insert. In this aspect, the first lid can sealingly engage the top surface of the flange portion of the insert. In an additional aspect, the method of sealing the product in the transport-ready position can comprise positioning the insert within an outer basin. In a further aspect, the method of sealing the product in the transport-ready position can comprise positioning the second lid over the outer basin to seal the insert within the outer basin. In this aspect, the second lid can sealingly engage the top surface of the outer basin.

In exemplary aspects, the first and second lids of the sealable tray system can respectively be heat-sealed to the insert and the outer basin using conventional methods. In further exemplary aspects, it is contemplated that the sealing of the insert within the outer basin can trap some air within the seal formed over the outer basin.

In exemplary aspects, and as further disclosed herein, the product 200 can comprise a tissue product. For example, in one aspect, the tissue product can comprise human placenta-derived tissue. In this aspect, the tissue product can comprise human placenta-derived membranes. Additionally or alternatively, the tissue product can comprise human umbilical cord. In another aspect, the tissue product can comprise human cadaveric tissue. In an additional aspect, the tissue product can comprise cartilage tissue. In a further aspect, the tissue product can comprise bone. In still another aspect, the tissue product can comprise meniscal tissue, such as, for example and without limitation, the meniscal tissue products disclosed in U.S. Patent Application Publication No. 2016/0310280, entitled “Compositions Comprising Meniscal Tissues and Uses Thereof,” which was published on Oct. 27, 2016 and is incorporated herein by reference in its entirety. In still another aspect, the tissue product can comprise epidermal tissue. In still another aspect, the tissue product can comprise intervertebral disc tissue.

In operation, it is contemplated that the sealable tray systems disclosed herein can require substantially less cryoprotectant solution than conventional tissue product packaging. Optionally, in these aspects, the sealable tray systems disclosed herein can require about 30 to about 80 percent less cryoprotectant solution than conventional product packaging.

In further exemplary aspects, the product can comprise a pre-loaded syringe containing a flowable tissue product. In still further exemplary aspects, the product can comprise a vial containing a flowable tissue product. In still further exemplary aspects, the product can comprise a pre-loaded syringe containing a fluid. In still further exemplary aspects, the product can comprise a vial containing a fluid. In still further exemplary aspects, the product can comprise a pre-loaded syringe containing a cryopreserved cell suspension. In still further exemplary aspects, the product can comprise a vial containing a cryopreserved cell suspension.

In various exemplary aspects, the product, the insert, the first lid, the outer basin, and the second lid can be sterilized. Optionally, in use, the product can be positioned and sealed within the insert in a sterile environment. As can be appreciated by one of ordinary skill in the art, positioning and sealing of the product within the insert in a sterile environment can allow physicians, physician's assistants, nurses, or other clinical workers to open the tray system to access the product in other sterile environments (e.g., an operating room) without jeopardizing the sterility of that environment.

### EXPERIMENTAL EXAMPLES

The presently described technology and its advantages will be better understood by reference to the following examples. These examples are provided to describe non-exhaustive embodiments of the present technology. By providing these examples, the scope of the presently described and claimed technology is not limited in spirit or scope. It will be understood by those skilled in the art that the full scope of the presently described technology encompasses at least the subject matter defined by the claims appending this specification, and any alterations, modifications, derivatives, combinations, or equivalents of those claims. Further, the citations provided herein are hereby incorporated by reference for the cited subject matter

### Example 1: Evaluating Cell Viability and Thawing Properties of Products Stored in Tray System

In one experimental example, the cell viability and thawing properties of a tissue product within a tray system as disclosed herein was evaluated. The materials used in this example included: a cell strainer, 100 um Mesh; collagenase, Worthington Type 2; DMEM; Trypsin-EDTA—0.05%; and Sodium Chloride Solution 0.9%. The product samples were GRAFIX Prime (OSIRIS THERAPEUTICS, Inc.) from two donors.

One group of product samples had dimensions of 5 cm×5 cm, and three samples from each donor were used for each of the following conditions: a. on Tritan plastic, in plastic tray (large insert); and b. on nitrocellulose, in FP90 cryobags (Charter Medical Ltd., Winston-Salem, NC).

Another group of product samples had dimensions of 2 cm×3 cm, and three samples from each donor were used for each of the following conditions: a. on Tritan plastic, in plastic tray (small insert); and b. on nitrocellulose, in FP90 cryobags.

The samples from one of the donors were used with flat outer basins, while the samples from the second donor were used with basins having ridges.

Protocol:

1. Amnion was obtained from manufacturing after day 1 processing.

2. After overnight incubation with antibiotics, amnion was mounted on plastic backing.

3. The top plastic cover was placed on top.

4. For group 1a, each graft was placed in the large insert and 20 mL of cryopreservation solution was added to make sure the graft is submerged in solution.

5. For group 2a, each graft was placed in the small insert and 10 mL of cryopreservation solution was added to make sure the graft is submerged in solution.

6. All other grafts were placed in FP-90 bags with 50 mL cryopreservation solution.

7. Tray samples were placed in boxes, while FP-90 bag samples were placed in manger pouches and in boxes.

8. All units were conditioned and frozen at −80° C. for overnight conditioning.

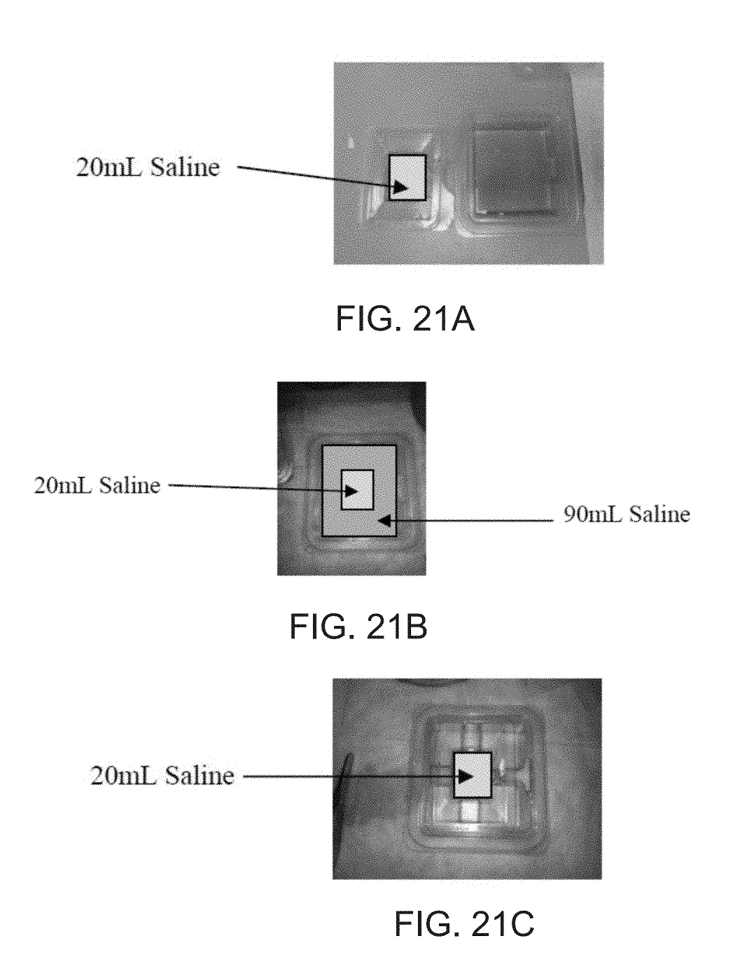

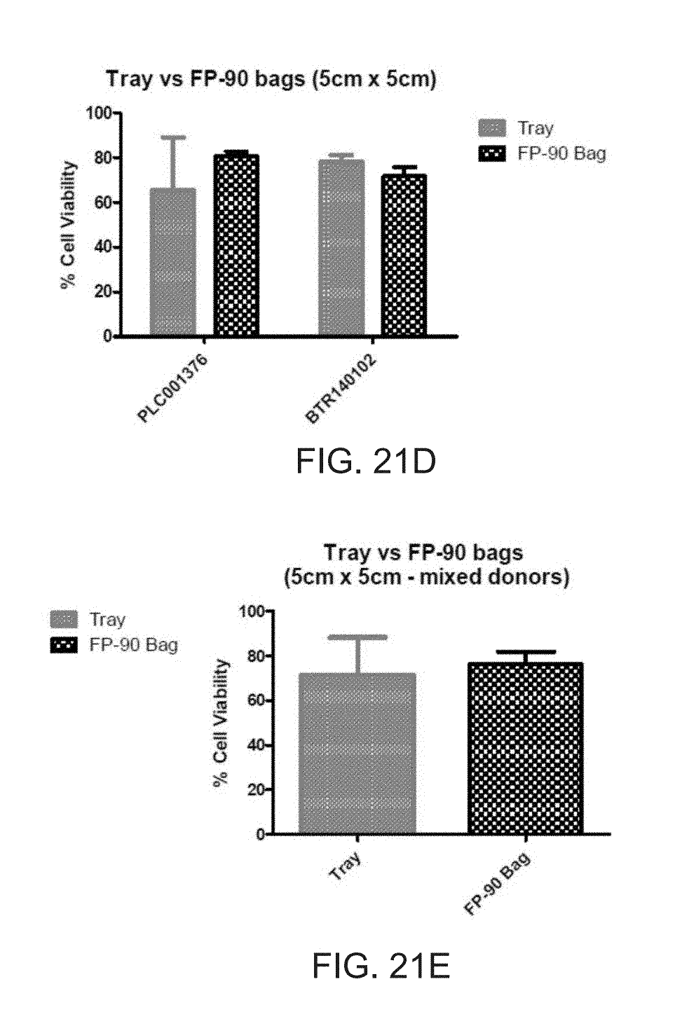

10. All units were thawed the following day using the following methods, and thawing time was observed and recorded:
a. Method #1: Remove insert from larger basin. Add 20 mL saline to insert (FIG. 21A).
b. Method #2: Keep the insert in the large basin. Add 20 mL saline to the insert and 90 mL saline to the large basin (FIG. 21B).
c. Method #3: Keep the insert in the large basin. Add 20 mL saline to the insert (FIG. 21C).

11. Cell viability counts were performed.

Method #2 for thawing Grafix in the tray had the fastest thawing time.

TABLE 1
Thaw Time and % Viable Cells for 5 cm × 5 cm Grafix Prime

| | | Thaw | Thaw Time | | | % Viable |
|---|---|---|---|---|---|---|
| Donor | Packaging | Method | (min.) | Viable Cells | Dead Cells | Cells |
| PLC001376 | Tray - large | #2 | 4 | 45 | 13 | 78% |
| | insert | | 3 (separate | 36 | 9 | 80% |
| | | | ice from | | | |
| | | | Grafix) | | | |
| | | | 3 | 6 | 10 | 38% |
| | FP-90 bag | In 37° C. | 4 | 37 | 9 | 80% |
| | | water bath | 4 | 117 | 24 | 83% |
| | | | 4 | 76 | 20 | 79% |
| BTR140102 | Tray - large | #2 | 6 | 50 | 17 | 75% |
| | insert | | 6 | 86 | 20 | 81% |
| | | | 7 (complete | 83 | 24 | 78% |
| | | | thaw) | | | |
| | FP-90 bag | In 37° C. | 4 | 32 | 11 | 74% |
| | | water bath | 4 | 25 | 9 | 74% |
| | | | 4 | 35 | 17 | 67% |

Table 1 and FIGS. 21D-21E show that there is no significant difference in cell viability for Grafix Prime 5 cm×5 cm when packaged in tray as compared to FP-90 bags. Table 1 also shows that when using Method #2 for thawing in the tray, on average thawing takes 4.8 minutes. The fastest thawing method for Grafix packaged in the tray was by adding 20 mL saline to the top of the insert and 90 mL saline to the large insert. For 2 cm×3 cm samples, average thawing time with this method was 7 min.

### Example 2: Evaluating Stability of Tray System on Benchtop

In a second experiment, the stability of products packaged in a tray system when placed on a benchtop was evaluated, and thawing times under these conditions were determined.

The samples used in this experimental example included: Grafix Prime—5 cm×5 cm (Osiris Therapeutics, Inc.), positioned on Tritan plastic, in a plastic tray (large insert); and Grafix Prime—2 cm×3 cm (Osiris Therapeutics, Inc.), positioned on Tritan plastic, in a plastic tray (small insert).

Protocol:

1. Amnion was obtained from manufacturing after day 1 processing.

2. After overnight incubation with antibiotics, amnion was mounted on plastic backing and cauterized.

3. A top plastic cover was placed on top and cauterized.

4. For group 1a, each graft was placed in a large insert and 20 mL of cryopreservation solution was added to make sure the graft is submerged in solution.

5. For group 2a, each graft was placed in a small insert and 10 mL of cryopreservation solution was added to make sure the graft is submerged in solution.

6. The tray systems containing the samples were placed in boxes and frozen at −80° C. for overnight.

Results:

TABLE 2

| | Time for 2 cm × 3 cm | Time for 5 cm × 5 cm |
|---|---|---|
| Significant thawing | 38 min | 57 min |
| around edges | | |
| Complete Thawing | 67 min | 87 min |

As summarized in Table 2, Grafix Prime 2 cm×3 cm units were stable on the benchtop for up to 38 minutes without significant thawing. 2 cm×3 cm units were completely thawed after 67 minutes. Grafix Prime 5 cm×5 cm units were stable on the benchtop for up to 57 minutes without significant thawing. 5 cm×5 cm units were completely thawed after 87 minutes.

### Example 3: Comparison of Post-Cryopreservation and Freezing Properties of Products Stored in Tray System to Products Stored in Vials

In a third experimental example, post-cryopreservation properties of a product packaged in a tray system were compared to the post-cryopreservation properties of products packaged in a vial. Additionally, the products were frozen with and without CRYOMED controlled rate freezers to evaluate the impact of simplifying the freezing protocol. The products used in this example were CARTIFORM (from bovine knee, OSIRIS THERAPEUTICS, Inc.).

Protocol:

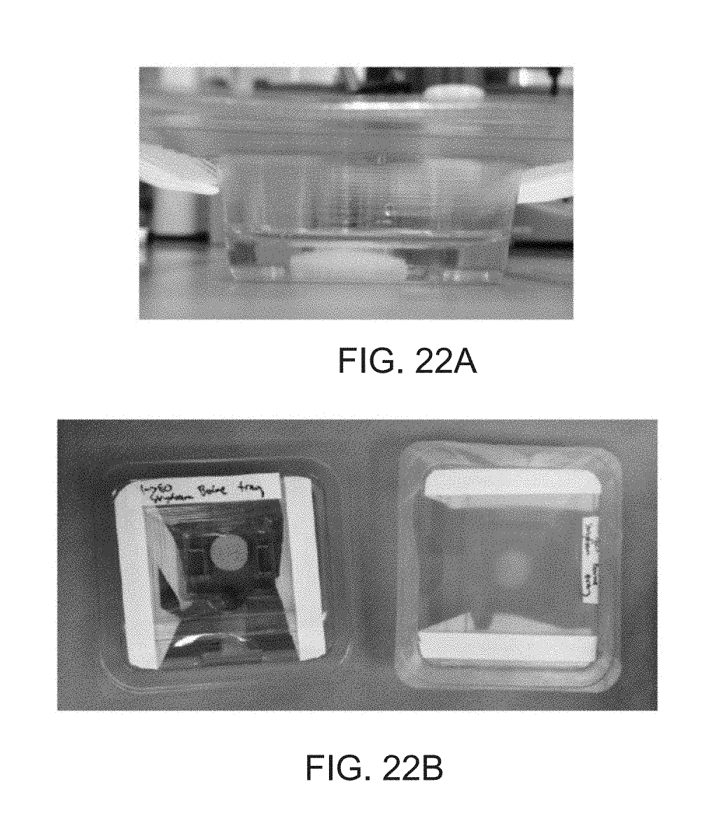

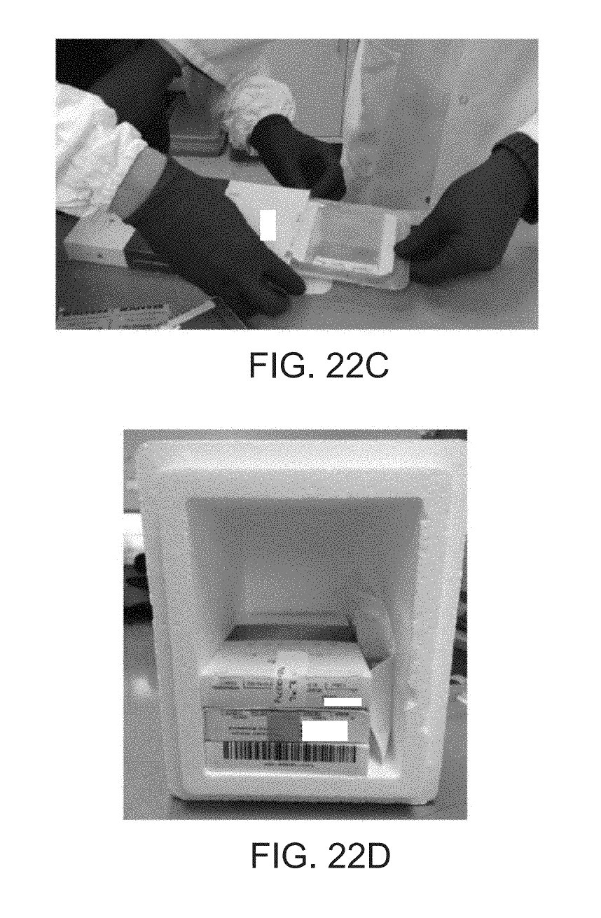

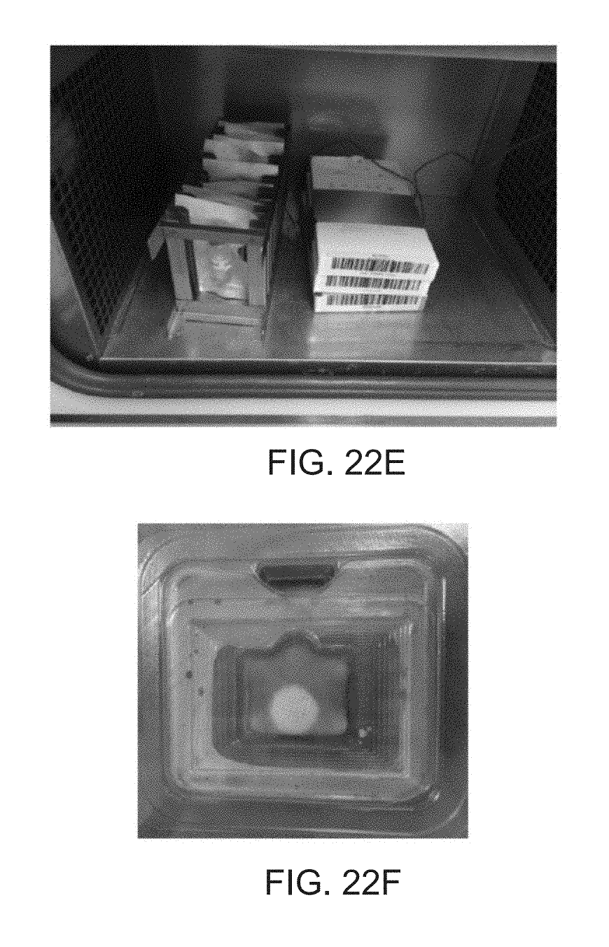

Six CARTIFORM units were packaged in tray systems, and the remaining units were packaged in vials. 7 ml cryopreservation solution was used in the tray systems and in the vials. FIG. 22A shows the appearance of a tray system with cryopreservation solution.

For the tray samples, as shown in FIGS. 22B-22C, the inner tray was covered with a sticky ELISA cover, and the outer tray was covered with Parafilm before the units were placed in boxes, being careful not to tilt (spill).

The CARTIFORM samples were frozen according to the following freezing conditions:

a. Simplified Freezing Method at −80° C. —3 CARTIFORM units in vials, 3 CARTIFORM units in trays (see FIG. 22D).

b. CRYOMED program (normal protocol), with 3 CARTIFORM units in vials and 3 CARTIFORM units in tray systems. FIG. 22E depicts the placemetn of the units in a CRYOMED freezer.

The CARTIFORM samples were thawed and tested for cell viability after being stored at −80° C. for 3 days. Room temperature saline was used to thaw the samples. For vial samples, the vial was placed in a basin filled with RT saline—time to thaw=7.5 minutes. For tray samples, the RT saline was placed in the bottom “wash basin” tray, and RT saline was also added over cryopreservation solution within the top tray—time to thaw=4 minutes. FIG. 22F depicts the appearance of the tray after adding RT saline to both trays.

### Example 4: Evaluating Cell Viability of Products Stored in Tray System

In a fourth experimental example, the cell viability of OvationOS (OSIRIS THERAPEUTICS, Inc.)-like material (5 cc) was evaluated. The sample material was frozen under normal conditions in a 15 mL straight side jar and in a tray system as disclosed herein. The samples were obtained from cow and human specimens.

Experimental Procedure:

Bone was processed in blender with 250 ml of dPBS per run. The material was passed over a sieve and the liquid was collected in a collection pan. The bone was rinsed with saline (about 100-200 ml). Additional cancellous bone and an additional 250 ml of dPBS was added to the blender and the process was repeated. This process was continued until all bone was processed and of sufficiently small size. Any remaining bone pieces were picked out. A succession of washing followed by the use of multiple sieves led to the selection of bone particles within a fixed particle size range. Liquid was decanted and excess fat stuck to side of tube was wiped out using sterile cloth. Material was weighed, returned to tube and placed in saline at 4° C. until ready to use. The final weight was 83 g.

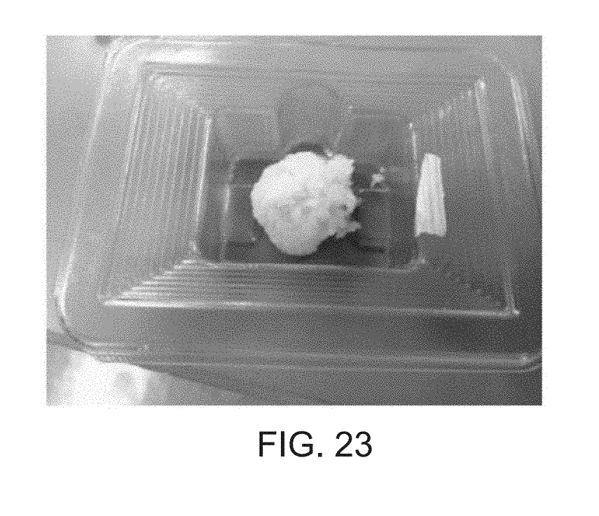

Freezing: After antibiotic treatment, all work was done in a hood. Antibiotic treatment was decanted. Material was washed twice in saline (200 ml per wash) and decanted. Material was transferred to 500 ml receiver bottle. 300 ml of Cyropreservation solution was added to OvationOS. Cryosolution was decanted, part into waste and part into sterile reservoir. Material was transferred to sterile reservoir, then measured for 5 ml samples. 5 cc OvationOS was transferred to a 15 mL straight sided jar or the small tray (15 cc size) with either the open bottom or locked bottom tray. Trays were wrapped in parafilm. All trays and jars were slowly frozen at −80° C. As shown in FIG. 23, 5 cc of OvationOS fits in the tray.

Two jars were placed in individual thaw bowls and filled with room temperature water until level was just below the lid. Thaw time-20 minutes.

Two jars were placed in racks in the 37° C. water. Thaw time-8 minutes.

One fixed placement bottom and one open bottom tray were filled with room temperature water. One fixed placement bottom and one open bottom tray were filled with 37° C. water (note open bottom trays floated).

The thawed sample material moved easily in the jar or tray and was easily malleable.

The thawing conditions are summarized in Table 3.

TABLE 3

| | Length |
|---|---|
| | (min) |
| Room Temperature Thaw-Jar | 20 |
| Room Temperature-Tray | 25 |
| 37° C. Thaw-Jar | 8 |
| 37° C. Thaw-Tray | 15 |

** started with 37° C. water, was not incubated in water bath

The tray with the ridges held the samples in place better than the open bottom tray, which allowed the top tray to move too freely.

Immediately after thawing, a 5 cc sample was transferred to a 50 ml conical tube, and digested with a collagenase solution to isolate cells. The cell suspension was then counted (10 μl of cell+10 μl of trypan blue).

Results are summarized in Table 4.

TABLE 4

| Control | Live | Dead | Total | Cells/ml | % Viability |
|---|---|---|---|---|---|
| 15 mL Jar-RT#1 | 49 | 6 | 55 | 2.45 × 10⁵ | 89 |
| 15 mL Jar-RT#2 | 65 | 7 | 72 | 3.25 × 10⁵ | 90 |
| Tray-RT#1 | 74 | 5 | 79 | 3.70 × 10⁵ | 94 |
| Tray-RT#1 | 46 | 5 | 51 | 2.30 × 10⁵ | 90 |
| 15 mL Jar-37° C.#1 | 79 | 8 | 87 | 3.95 × 10⁵ | 91 |
| 15 mL Jar-37° C.#2 | 68 | 5 | 73 | 3.40 × 10⁵ | 93 |
| Tray-37° C.#1 | 44 | 4 | 48 | 2.20 × 10⁵ | 92 |
| Tray-37° C.#2 | 54 | 4 | 58 | 2.70 × 10⁵ | 93 |

Based on these results, the viability was maintained.

### EXEMPLARY ASPECTS

In view of the described sealable tray systems and methods and variations thereof, herein below are described certain more particularly described aspects of the invention. These particularly recited aspects should not, however, be interpreted to have any limiting effect on any different claims containing different or more general teachings described herein, or that the “particular” aspects are somehow limited in some way other than the inherent meanings of the language literally used.

Aspect 1: A sealable tray system for sealing a product in a transport-ready position, comprising: an insert having a central axis, a flange portion, and a well portion, the flange portion having a top surface and a bottom surface, the well portion having a side wall and a base surface, the side wall connected to and extending between the flange portion of the insert and the base surface of the well portion, the side wall having an inner surface and an outer surface, the base surface of the well portion defining at least one projection that extends upwardly relative to the central axis of the insert and is configured to support the product, wherein the flange portion extends radially outwardly from the outer surface of the side wall of the well portion relative to the central axis of the insert; a first lid configured to sealingly engage the top surface of the flange portion of the insert; an outer basin configured to receive the insert in the transport-ready position, the outer basin having a central axis, a flange portion, a ledge portion, a base surface, and a side wall, the flange portion defining a top surface of the outer basin, the side wall of the outer basin having an inner surface and an outer surface and being connected to and extending upwardly from the base surface of the outer basin relative to the central axis of the outer basin, the ledge portion of the outer basin being connected to and extending between the flange portion and the side wall, the flange portion extending radially outwardly from the ledge portion relative to the central axis of the outer basin, the ledge portion of the outer basin defining a ledge surface, the ledge surface being recessed from the top surface of the outer basin relative to the central axis and extending radially inwardly from the flange portion relative to the central axis; and a second lid configured to sealingly engage the top surface of the outer basin, wherein the ledge surface of the outer basin is configured for engagement with the bottom surface of the flange portion of the insert to thereby support the insert in the transport-ready position.

Aspect 2: The sealable tray system of aspect 1, wherein the top surface of the outer basin defines at least one ridge, the at least one ridge projecting upwardly from the top surface of the outer basin relative to the central axis of the outer basin, wherein the at least one ridge is configured to cooperate with the second lid to form a seal over the insert.

Aspect 3: The sealable tray system of aspect 2, wherein the ledge portion of the outer basin comprises a wall surface extending downwardly from the top surface of the outer basin relative to the central axis of the outer basin, wherein the ledge surface of the ledge portion extends radially inwardly from the wall surface relative to the central axis of the outer basin, and wherein the wall surface of the ledge portion defines at least one radial projection spaced from the ledge surface relative to the central axis of the outer basin.

Aspect 4: The sealable tray system of aspect 3, wherein the at least one radial projection and the ledge surface of the ledge portion of the outer basin cooperate to define a receiving space, and wherein the receiving space is configured to receive an outer portion of the flange portion of the insert.

Aspect 5: The sealable tray system of aspect 4, wherein the bottom surface of the flange portion of the insert defines at least one stabilizing projection extending downwardly from the bottom surface of the flange portion relative to the central axis of the insert, and wherein the at least one stabilizing projection is configured to restrict radial movement of the insert relative to the central axis of the insert.

Aspect 6: The sealable tray system of aspect 5, wherein the top surface of the flange portion of the insert defines at least one ridge, the at least one ridge projecting upwardly from the top surface of the flange portion relative to the central axis of the insert, wherein the at least one ridge is configured to cooperate with the first lid to form a seal over the well portion of the insert.

Aspect 7: The sealable tray system of any one of the preceding aspects, wherein the inner surface of the side wall of the outer basin has a first side that defines a radially recessed portion of the side wall of the outer basin, wherein the inner surface of the side wall of the well portion of the insert has a first side that defines a radially recessed portion of the side wall of the well portion of the insert, and wherein the radially recessed portion of the side wall of the outer basin is positioned in substantial alignment with the radially recessed portion of the side wall of the well portion of the insert when the insert is positioned in the transport-ready position.

Aspect 8: The sealable tray system of aspect 7, wherein the flange portion of the insert has a first side that defines a notch positioned in substantial alignment with the radially extended portion of the side wall of the well portion of the insert.

Aspect 9: The sealable tray system of aspect 7, wherein the inner surface of the side wall of the well portion of the insert has a second side opposed from the first side and third and fourth sides that extend between the first and second sides, the third side being opposed from the fourth side, wherein the at least one projection of the base surface of the insert comprises first and second projections, wherein the first projection is positioned proximate the third side of the inner surface of the side wall of the well portion of the insert, and wherein the second projection is positioned proximate the fourth side of the inner surface of the side wall of the well portion of the insert.

Aspect 10: The sealable tray system of aspect 9, wherein the first projection extends radially inwardly from the third side of the inner surface of the side wall of the well portion of the insert relative to the central axis of the insert, and wherein the second projection extends radially inwardly from the fourth side of the inner surface of the side wall of the well portion of the insert relative to the central axis of the insert.

Aspect 11: The sealable tray system of aspect 7, wherein the inner surface of the side wall of the well portion of the insert has a second side opposed from the first side and third and fourth sides that extend between the first and second sides, the third side being opposed from the fourth side, wherein the at least one projection of the base surface of the insert comprises a first row of at least two spaced projections and a second row of at least two spaced projections.

Aspect 12: The sealable tray system of aspect 11, wherein the projections of the first row of at least two spaced projections are spaced apart relative to a first transverse axis, wherein the projections of the second row of at least two spaced projections are spaced apart relative to the first transverse axis, and wherein the first row of at least two spaced projections is spaced from the second row of at least two spaced projections relative to a second transverse axis that is perpendicular or substantially perpendicular to the first transverse axis.

Aspect 13: The sealable tray system of aspect 12, wherein the first row of at least two spaced projections is spaced from the third side by a selected distance relative to the second transverse axis, and wherein the second row of at least two spaced projections is spaced from the fourth side by the selected distance relative to the second transverse axis.

Aspect 14: The sealable tray system of aspect 12, wherein the first and second rows of at least two spaced projections comprise first and second spaced projections.

Aspect 15: The sealable tray system of any one of the preceding aspects, wherein the flange portion of the insert has a sloped surface and a lip, the sloped surface of the flange portion of the insert extending between the lip of the flange portion and the side wall of the well portion of the insert, the lip of the flange portion of the insert extending radially outwardly from the sloped surface of the flange portion relative to the central axis of the insert, wherein the lip of the flange portion defines the top surface and the bottom surface of the flange portion of the insert.

Aspect 16: The sealable tray system of aspect 15, wherein the sloped surface of the flange portion of the insert extends between the side wall of the well portion of the insert and the lip of the flange portion of the insert at a selected angle relative to the central axis of the insert.

Aspect 17: The sealable tray system of aspect 16, wherein the selected angle ranges from about 45 degrees to about 90 degrees.

Aspect 18: A method of sealing a product in a transport-ready position, comprising: positioning the product within an insert, the insert having a central axis, a flange portion, and a well portion, the flange portion having a top surface and a bottom surface, the well portion having a side wall and a base surface, the side wall connected to and extending between the flange portion of the insert and the base surface of the well portion, the side wall having an inner surface and an outer surface, the base surface of the well portion defining at least one projection that extends upwardly relative to the central axis of the insert and supports the product within the well portion, wherein the flange portion extends radially outwardly from the outer surface of the side wall of the well portion relative to the central axis of the insert; positioning a first lid over the well portion to seal the product within the insert, the first lid sealingly engaging the top surface of the flange portion of the insert; positioning the insert within an outer basin in a transport-ready position, the outer basin having a central axis, a flange portion, a ledge portion, a base surface, and a side wall, the flange portion defining a top surface of the outer basin, the side wall of the outer basin being connected to and extending upwardly from the base surface of the outer basin relative to the central axis of the outer basin, the ledge portion of the outer basin being connected to and extending between the flange portion and the side wall, the flange portion extending radially outwardly from the ledge portion relative to the central axis of the outer basin, the ledge portion of the outer basin defining a ledge surface, the ledge surface being recessed from the top surface of the outer basin relative to the central axis and extending radially inwardly from the flange portion relative to the central axis, wherein the ledge surface of the outer basin engages the bottom surface of the flange portion of the insert to thereby support the insert in the transport-ready position; and positioning a second lid over the outer basin to seal the insert within the outer basin, wherein the second lid sealingly engages the top surface of the outer basin.

Aspect 19: The method of aspect 18, wherein the flange portion of the insert has a sloped surface and a lip, the sloped surface of the flange portion of the insert extending between the lip of the flange portion and the side wall of the well portion, the lip of the flange portion extending radially outwardly from the sloped surface of the flange portion relative to the central axis of the insert, wherein the lip of the flange portion defines the top surface and the bottom surface of the flange portion of the insert.

Aspect 20: The method of aspect 18 or aspect 19, wherein the product comprises a tissue product.

Aspect 21: The method of aspect 20, wherein the tissue product comprises human placenta-derived tissue.

Aspect 22: The method of aspect 21, wherein the tissue product comprises human placenta-derived membranes.

Aspect 23: The method of aspect 21, wherein the tissue product comprises human umbilical cord.

Aspect 24: The method of aspect 20, wherein the tissue product comprises human cadaveric tissue.

Aspect 25: The method of aspect 24, wherein the tissue product comprises cartilage tissue.

Aspect 26: The method of aspect 24, wherein the tissue product comprises bone.

Aspect 27: The method of aspect 24, wherein the tissue product comprises meniscal tissue.

Aspect 28: The method of aspect 24, wherein the tissue product comprises epidermal tissue.

Aspect 29: The method of aspect 24, wherein the tissue product comprises intervertebral disc tissue.

Aspect 30: The method of any one of the preceding aspects, wherein the product comprises a pre-loaded syringe containing a flowable tissue product.

Aspect 31: The method of any one of the preceding aspects, wherein the product comprises a vial containing a flowable tissue product.

Aspect 32: The method of any one of the preceding aspects, wherein the product comprises a pre-loaded syringe containing a fluid.

Aspect 33: The method of any one of the preceding aspects, wherein the product comprises a vial containing a fluid.

Aspect 34: The method of any one of the preceding aspects, wherein the product comprises a pre-loaded syringe containing a cryopreserved cell suspension.

Aspect 35: The method of any one of the preceding aspects, wherein the product comprises a vial containing a cryopreserved cell suspension.

Aspect 36: The method of any one of the preceding aspects, wherein the product, the insert, the first lid, and the second lid are sterilized, and wherein the product is positioned and sealed within the insert in a sterile environment.

All publications and patent applications mentioned in the specification are indicative of the level of those skilled in the art to which this invention pertains. All publications and patent applications are herein incorporated by reference to the same extent as if each individual publication or patent application was specifically and individually indicated to be incorporated by reference.

Although the foregoing invention has been described in some detail by way of illustration and example for purposes of clarity of understanding, certain changes and modifications may be practiced within the scope of the appended claims.

What is claimed is:

1. A sealable tray system for sealing a product in a transport-ready position, comprising:
an insert having a central axis, a flange portion, and a well portion, the flange portion having a top surface and a bottom surface, the well portion having a side wall and a base surface, the side wall connected to and extending between the flange portion of the insert and the base surface of the well portion, the side wall having an inner surface and an outer surface, the base surface of the well portion defining at least one projection that extends upwardly relative to the central axis of the insert and is configured to support the product, wherein the flange portion extends radially outwardly from the outer surface of the side wall of the well portion relative to the central axis of the insert;
a first lid configured to sealingly engage the top surface of the flange portion of the insert;
an outer basin configured to receive the insert in the transport-ready position, the outer basin having a central axis, a flange portion, a ledge portion, a base surface, and a side wall, the flange portion defining a top surface of the outer basin, the side wall of the outer basin having an inner surface and an outer surface and being connected to and extending upwardly from the base surface of the outer basin relative to the central axis of the outer basin, the ledge portion of the outer basin being connected to and extending between the flange portion and the side wall, the flange portion extending radially outwardly from the ledge portion relative to the central axis of the outer basin, the ledge portion of the outer basin defining a ledge surface, the ledge surface being recessed from the top surface of the outer basin relative to the central axis and extending radially inwardly from the flange portion relative to the central axis; and
a second lid configured to sealingly engage the top surface of the outer basin,
wherein the ledge surface of the outer basin is configured for engagement with the bottom surface of the flange portion of the insert to thereby support the insert in the transport-ready position.

2. The sealable tray system of claim 1, wherein the top surface of the outer basin defines at least one ridge, the at least one ridge projecting upwardly from the top surface of the outer basin relative to the central axis of the outer basin, wherein the at least one ridge is configured to cooperate with the second lid to form a seal over the insert.

3. The sealable tray system of claim 2, wherein the ledge portion of the outer basin comprises a wall surface extending downwardly from the top surface of the outer basin relative to the central axis of the outer basin, wherein the ledge surface of the ledge portion extends radially inwardly from the wall surface relative to the central axis of the outer basin, and wherein the wall surface of the ledge portion defines at least one radial projection spaced from the ledge surface relative to the central axis of the outer basin.

4. The sealable tray system of claim 3, wherein the at least one radial projection and the ledge surface of the ledge portion of the outer basin cooperate to define a receiving space, and wherein the receiving space is configured to receive an outer portion of the flange portion of the insert.

5. The sealable tray system of claim 4, wherein the bottom surface of the flange portion of the insert defines at least one stabilizing projection extending downwardly from the bottom surface of the flange portion relative to the central axis of the insert, and wherein the at least one stabilizing projection is configured to restrict radial movement of the insert relative to the central axis of the insert.

6. The sealable tray system of claim 5, wherein the top surface of the flange portion of the insert defines at least one ridge, the at least one ridge projecting upwardly from the top surface of the flange portion relative to the central axis of the insert, wherein the at least one ridge is configured to cooperate with the first lid to form a seal over the well portion of the insert.

7. The sealable tray system of claim 1, wherein the inner surface of the side wall of the outer basin has a first side that defines a radially recessed portion of the side wall of the outer basin, wherein the inner surface of the side wall of the well portion of the insert has a first side that defines a radially recessed portion of the side wall of the well portion of the insert, and wherein the radially recessed portion of the side wall of the outer basin is positioned in substantial alignment with the radially recessed portion of the side wall of the well portion of the insert when the insert is positioned in the transport-ready position.

8. The sealable tray system of claim 7, wherein the flange portion of the insert has a first side that defines a notch positioned in substantial alignment with the radially extended portion of the side wall of the well portion of the insert.

9. The sealable tray system of claim 7, wherein the inner surface of the side wall of the well portion of the insert has a second side opposed from the first side and third and fourth sides that extend between the first and second sides, the third side being opposed from the fourth side, wherein the at least one projection of the base surface of the insert comprises first and second projections, wherein the first projection is positioned proximate the third side of the inner surface of the side wall of the well portion of the insert, and wherein the second projection is positioned proximate the fourth side of the inner surface of the side wall of the well portion of the insert.

10. The sealable tray system of claim 9, wherein the first projection extends radially inwardly from the third side of the inner surface of the side wall of the well portion of the insert relative to the central axis of the insert, and wherein the second projection extends radially inwardly from the fourth side of the inner surface of the side wall of the well portion of the insert relative to the central axis of the insert.

11. The sealable tray system of claim 7, wherein the inner surface of the side wall of the well portion of the insert has a second side opposed from the first side and third and fourth sides that extend between the first and second sides, the third side being opposed from the fourth side, wherein the at least one projection of the base surface of the insert comprises a first row of at least two spaced projections and a second row of at least two spaced projections.

12. The sealable tray system of claim 11, wherein the projections of the first row of at least two spaced projections are spaced apart relative to a first transverse axis, wherein the projections of the second row of at least two spaced projections are spaced apart relative to the first transverse axis, and wherein the first row of at least two spaced projections is spaced from the second row of at least two spaced projections relative to a second transverse axis that is substantially perpendicular to the first transverse axis.

13. The sealable tray system of claim 12, wherein the first row of at least two spaced projections is spaced from the third side by a selected distance relative to the second transverse axis, and wherein the second row of at least two spaced projections is spaced from the fourth side by the selected distance relative to the second transverse axis.

14. The sealable tray system of claim 12, wherein the first and second rows of at least two spaced projections comprise first and second spaced projections.

15. The sealable tray system of claim 1, wherein the flange portion of the insert has a sloped surface and a lip, the sloped surface of the flange portion of the insert extending between the lip of the flange portion and the side wall of the well portion of the insert, the lip of the flange portion of the insert extending radially outwardly from the sloped surface of the flange portion relative to the central axis of the insert, wherein the lip of the flange portion defines the top surface and the bottom surface of the flange portion of the insert.

16. The sealable tray system of claim 15, wherein the sloped surface of the flange portion of the insert extends between the side wall of the well portion of the insert and the lip of the flange portion of the insert at a selected angle relative to the central axis of the insert.

17. The sealable tray system of claim 16, wherein the selected angle ranges from about 45 degrees to about 90 degrees.

18. A method of sealing a product in a transport-ready position, comprising:
positioning the product within an insert, the insert having a central axis, a flange portion, and a well portion, the flange portion having a top surface and a bottom surface, the well portion having a side wall and a base surface, the side wall connected to and extending between the flange portion of the insert and the base surface of the well portion, the side wall having an inner surface and an outer surface, the base surface of the well portion defining at least one projection that extends upwardly relative to the central axis of the insert and supports the product within the well portion, wherein the flange portion extends radially outwardly from the outer surface of the side wall of the well portion relative to the central axis of the insert;
positioning a first lid over the well portion to seal the product within the insert, the first lid sealingly engaging the top surface of the flange portion of the insert;
positioning the insert within an outer basin in a transport-ready position, the outer basin having a central axis, a flange portion, a ledge portion, a base surface, and a side wall, the flange portion defining a top surface of the outer basin, the side wall of the outer basin being connected to and extending upwardly from the base surface of the outer basin relative to the central axis of the outer basin, the ledge portion of the outer basin being connected to and extending between the flange portion and the side wall, the flange portion extending radially outwardly from the ledge portion relative to the central axis of the outer basin, the ledge portion of the outer basin defining a ledge surface, the ledge surface being recessed from the top surface of the outer basin relative to the central axis and extending radially inwardly from the flange portion relative to the central axis, wherein the ledge surface of the outer basin engages the bottom surface of the flange portion of the insert to thereby support the insert in the transport-ready position; and
positioning a second lid over the outer basin to seal the insert within the outer basin, wherein the second lid sealingly engages the top surface of the outer basin.

19. The method of claim 18, wherein the flange portion of the insert has a sloped surface and a lip, the sloped surface of the flange portion of the insert extending between the lip of the flange portion and the side wall of the well portion, the lip of the flange portion extending radially outwardly from the sloped surface of the flange portion relative to the central axis of the insert, wherein the lip of the flange portion defines the top surface and the bottom surface of the flange portion of the insert.

20. The method of claim 18, wherein the product comprises a tissue product.
